(19) United States
(12) Patent Application Publication
(10) Pub. No.: US 2020/0104898 A1
(43) Pub. Date: Apr. 2, 2020

(54) ACCESSORY RECOMMENDATION

(71) Applicant: Home Depot Product Authority, LLC, Atlanta, GA (US)

(72) Inventors: Xiquan Cui, Atlanta, GA (US); Huiming Qu, Atlanta, GA (US); Estelle Afshar, Atlanta, GA (US); San-He Wu, Atlanta, GA (US)

(21) Appl. No.: 16/143,723

(22) Filed: Sep. 27, 2018

(51) Int. Cl. G06Q 30/06

(52) U.S. Cl. CPC G06Q 30/0631; G06Q 30/0643; G06Q 30/0633

(57) ABSTRACT

This disclosure includes systems and methods for providing accessory product recommendations to a user that may include items related to an anchor product selected by the user. The determination of accessory product recommendations may be made based on compatibility between anchor and accessory products, based on manually entered anchor-accessory product relationships, using an algorithm trained to determine anchor-accessory product relationships, or using other methods. The accessory recommendations may be provided along with the anchor product on an electronic user interface, such as a website, in response to the user's selection of the product through the electronic user interface. In this way, the accessory and anchor products may be viewed and/or selected by the user with a minimal number of clicks or user interactions through the electronic user interface.

### FIELD OF THE DISCLOSURE

This disclosure is generally directed to providing recommendations to a user through an electronic interface, including providing recommendations for accessory products.

### BACKGROUND OF RELATED ART

Both a retailer and its customers can benefit from the retailer providing recommendations for products that may be of use to the customers. The retailer may provide product recommendations on a website, in a brick-and-mortar store, or otherwise. Recommendations may increase the retailer's sales, and may introduce useful or necessary products to the customer that the customer may otherwise not have found or been aware of.

### SUMMARY

An illustrative method of providing an accessory recommendation to a user includes receiving, from a user electronic device, a selection of an anchor product through an electronic user interface. The method further includes determining an accessory product related to the anchor product. The method further includes sending, to the user electronic device, information about the accessory product and the anchor product to display together on the electronic user interface. The accessory product is determined to be an accessory related to the anchor product at least in part by determining an anchor product category of the anchor product and determining a plurality of other anchor products that are in the anchor product category. The accessory product is further determined at least in part by determining, based on the plurality of other anchor products, a plurality of accessory products from a list of manually entered anchor-accessory product relationships that are recommended for the plurality of other anchor products. The accessory product is further determined at least in part by selecting the accessory product to recommend for the anchor product from the plurality of accessory products.

An illustrative method of providing an accessory recommendation to a user includes receiving, from a user electronic device, a selection of an anchor product through an electronic user interface. The method further includes determining an accessory product related to the anchor product. The method further includes sending, to the user electronic device, information about the accessory product and the anchor product to display together on the electronic user interface. The accessory product is determined to be an accessory related to the anchor product at least in part by determining a plurality of potential accessory products and comparing first text associated with the anchor product to respective second text associated with each of the plurality of potential accessory products. The accessory product is further determined at least in part by selecting, based on the comparison of the first text to the second texts, the accessory product to recommend for the anchor product from the plurality of accessory products.

An illustrative method of determining a list of anchor-accessory relationships includes determining a first anchor-accessory relationship based on a list of manually entered anchor-accessory product relationships. Determining the first anchor-accessory relationship includes determining an anchor product category of a first anchor product that is not associated with any anchor-accessory relationship in the list of manually entered anchor-accessory product relationships. Determining the first anchor-accessory relationship further includes determining a plurality of other anchor products that are in the anchor product category. Determining the first anchor-accessory relationship further includes determining, based on the plurality of other anchor products in the anchor product category, a plurality of accessory products from the list of manually entered anchor-accessory product relationships that are recommended for the plurality of other anchor products. Determining the first anchor-accessory relationship further includes determining that a first accessory product of the plurality of accessory products has been co-purchased with the anchor product a highest number of times among the plurality of accessory products. Determining the first anchor-accessory relationship further includes establishing the first anchor-accessory relationship between the first anchor product and the first accessory product. Determining the first anchor-accessory relationship further includes storing the first anchor-accessory relationship between the first anchor product and the first accessory product in the list of anchor-accessory product relationships. The method further includes determining a second anchor-accessory relationship based on attribute compatibility. Determining the second anchor-accessory relationship includes determining that a second accessory product and a second anchor product have at least one compatible attribute based on product names or descriptions of the second accessory product and the second anchor product. Determining the second anchor-accessory relationship further includes establishing the second anchor-accessory relationship between the second anchor product and the second accessory product. Determining the second anchor-accessory relationship further includes storing the second anchor-accessory relationship between the second anchor product and the second accessory product in the list of anchor-accessory product relationships. The method further includes receiving, from a user electronic device, a selection of the first anchor product or the second anchor product through an electronic user interface. The method further includes determining, based on the list of anchor-accessory relationships, a correct accessory product related to the selection. The method further includes sending, to the user electronic device, information about the correct accessory product related to the selection to display on the electronic user interface.

### BRIEF DESCRIPTION OF THE DRAWINGS

FIG. 1 is a flow chart illustrating an example method of providing accessory item recommendations to a user, in embodiments.

FIG. 2 is a block diagram view of an example system for providing accessory item recommendations to a user, in embodiments.

FIG. 3 is a flow chart illustrating an example method of determining an accessory product to recommend to a user based on a list of manually entered anchor-accessory product relationships, in embodiments.

FIG. 4 is a flow chart illustrating an example method of determining an accessory product to recommend to a user based on a text comparison, in embodiments.

FIG. 5 is a flow chart illustrating an example method of determining attribute compatibility between an anchor and accessory product, in embodiments.

FIG. 6 is a flow chart illustrating an example method of determining a generic accessory recommendation to recommend to a user, in embodiments.

FIG. 7 is a flow chart illustrating an example method of building a list or table of anchor-accessory product relationships, in embodiments.

FIG. 8 illustrates an example graphical presentation of an anchor product and accessory product recommendations presented to a user, in embodiments.

FIGS. 9A and 9B are tables showing example criteria for selecting accessory products based on a list of manually entered anchor-accessory product relationships, in embodiments.

FIGS. 10A-10C are tables showing an example of selecting accessory products based on a list of manually entered anchor-accessory product relationships and co-purchase data, in embodiments.

FIGS. 11A-11C are tables showing an example of selecting accessory products based on in-store and online co-purchase transaction data, in embodiments.

FIGS. 12A and 12B are tables showing an example of selecting accessory products based on a list of manually entered anchor-accessory product relationships and co-purchase data, in embodiments.

FIG. 13A is a table showing examples of compatibility rules for selecting recommended accessories based on attribute compatibility, in embodiments.

FIGS. 13B and 13C illustrate example graphical representations of different light bulb attributes, in embodiments.

FIG. 14 is a table showing attribute compatibility of three different accessory light bulbs with an anchor light fixture, in embodiments.

FIG. 15 is a table showing attribute priority for determining an accessory product based on attribute compatibility, in embodiments.

FIG. 16 is a table showing examples of determining generic accessory recommendations for various anchor categories of products, in embodiments.

FIG. 17 illustrates an example graphical presentation of a tool for verifying the output of a generic accessory recommendation generator, in embodiments.

FIG. 18 is a table showing criteria for determining generic accessory recommendations, in embodiments.

FIG. 19 is a table showing training/testing data for training an algorithm to determine anchor-accessory relationships and new test data to feed into a trained algorithm, in embodiments.

FIGS. 20-22 are tables showing data used with an algorithm for determining new anchor-accessory relationships, in embodiments.

FIG. 23 illustrates example results from an example algorithm for determining new anchor-accessory relationships, in embodiments.

FIG. 24 is a diagrammatic view of an example user computing environment, according to some embodiments.

### DETAILED DESCRIPTION

The present disclosure includes systems and methods for providing accessory recommendations to be displayed to a user (e.g., for purchase by the user). The accessory recommendations, or accessory product, may be provided in conjunction with the viewing, selection, or purchase of an anchor product through an electronic user interface, such as one on an e-commerce website, a mobile application, a kiosk in a brick-and-mortar store, or elsewhere. Further, the accessory recommendations may be provided by an in-store associate to a customer based on that customer's question about or interest in a product. Still further, accessory recommendations may be provided on a digital price display (e.g., in a brick-and-mortar retail store) associated with the anchor product. The accessory recommendations may include items, such as products, that are complementary to an anchor item. For example, a paint brush may be recommended as a complementary accessory to an anchor product of paint. For the remainder of this disclosure, accessory recommendations will generally be described as being provided on a website. Such disclosure is by way of example only. The same or similar functionality described herein as being provided on or through a website may also be provided through a mobile application, in-store kiosk, or otherwise.

Numerous websites and retailers provide product purchase recommendations. Many websites, however, provide product recommendations that are not finely-tuned to the customer's needs. For example, the inventors of the instant disclosure have appreciated that many retailers provide product recommendations that are redundant with one another, are not compatible with one another, and/or are not related to one another. Advantageously, the systems and methods described herein provide embodiments for determining and presenting better accessory product recommendations for display and potential purchase along with anchor products being viewed by a user.

The systems and methods described herein also include embodiments for determining anchor-accessory relationships. Where a relationship between an anchor and accessory product has been determined, the accessory product can be recommended for display and potential purchase along with the anchor product. Various embodiments for determining these anchor-accessory relationships are described herein.

Providing accessory recommendations to a user according to the present disclosure may allow a user to more quickly view and/or purchase numerous items through an electronic interface, such as a website. For example, accessory recommendations may be provided to a user along with an anchor product selected by the user, and the user may purchase both the selected product and the recommended accessory product(s) with a reduced number of clicks relative to known processes (or other user interactions such as voice commands, touch screen gestures, etc.). In various embodiments, graphical control elements may be provided that enable the user to select and purchase the anchor product and the recommended accessory product(s) from a single page or interface portion, thereby reducing user time and effort by eliminating the need for the user to separately navigate to the product page of each recommended accessory product(s). As a result, providing accessory product recommendations according to the techniques of the present disclosure solves an internet-centric problem-streamlining user interaction with a website or other electronic user interface-through methods and systems necessarily rooted in computer technology. Additionally, the techniques described herein provide improved functioning of a website accessed by a user. For example, according to the various techniques described herein, a database or lookup table of relationships between various anchor products and accessory products can be built before a user accesses the website and selects an anchor product to view and potentially purchase. Because the database or lookup table of relationships is already established, the accessory products related to a selected anchor product can be looked up in the database or lookup table and populated on the website for viewing and potential purchase by the user. Using such techniques, the accessory products can be looked up and loaded onto the website interface viewed by the user faster than if an anchor-accessory relationship was determined in response to a user selecting an anchor product to purchase. In addition, the methods and systems described herein provide an improved graphical user interface (GUI). Displaying at least one anchor product and one or more accessory products on a single interface is a demonstrable improvement that allows user to quickly and easily select, unselect, add to a cart, purchase, view, and otherwise interact with anchor and relevant accessory products on a single interface, such as a webpage. In other words, the methods and systems herein provide for a particular manner of summarizing and presenting information by and on electronic devices, and include specific manners of displaying a limited set of relevant information to a user, rather than using conventional user interface methods to display generic information on a computer. In particular, the improved interfaces described herein prevent a user from having to view anchor and accessory products on more than one interface or webpage. This allows a user to see the most relevant data quickly, and saves the user from the time and hassle of navigating through multiple interfaces and webpages.

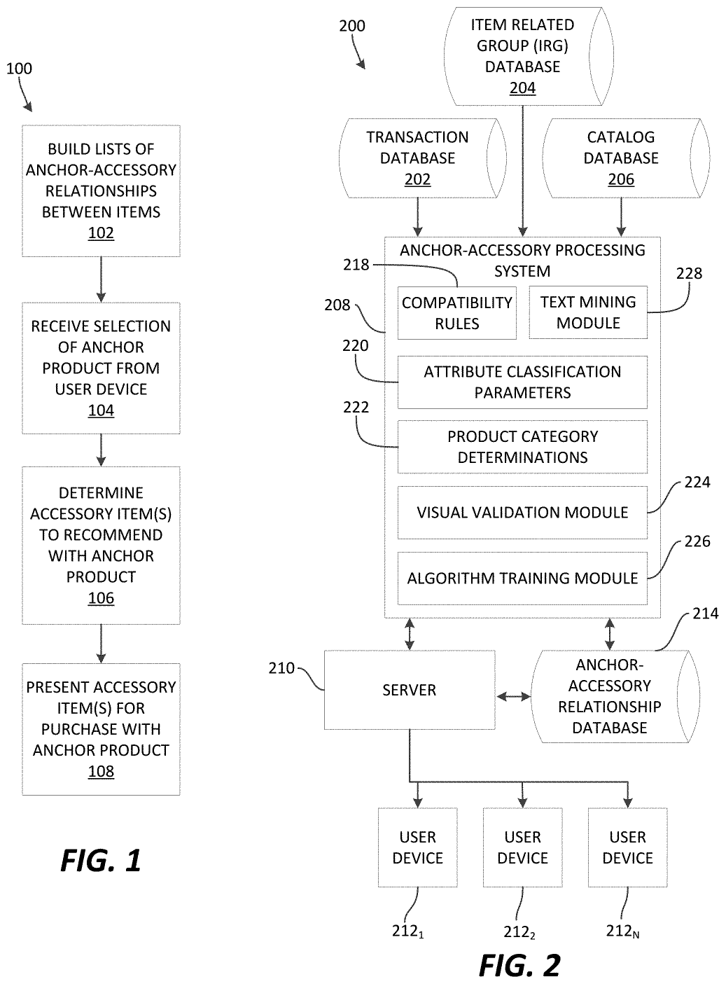

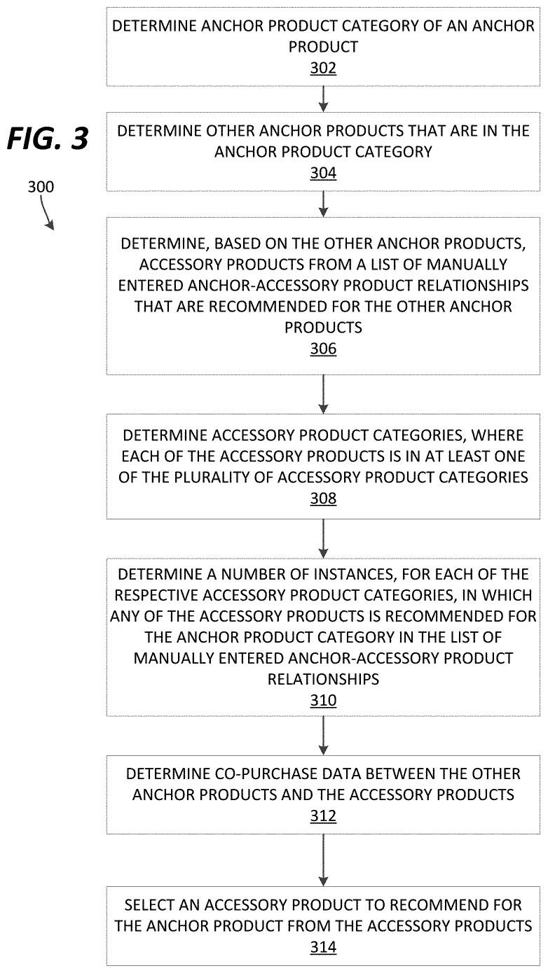

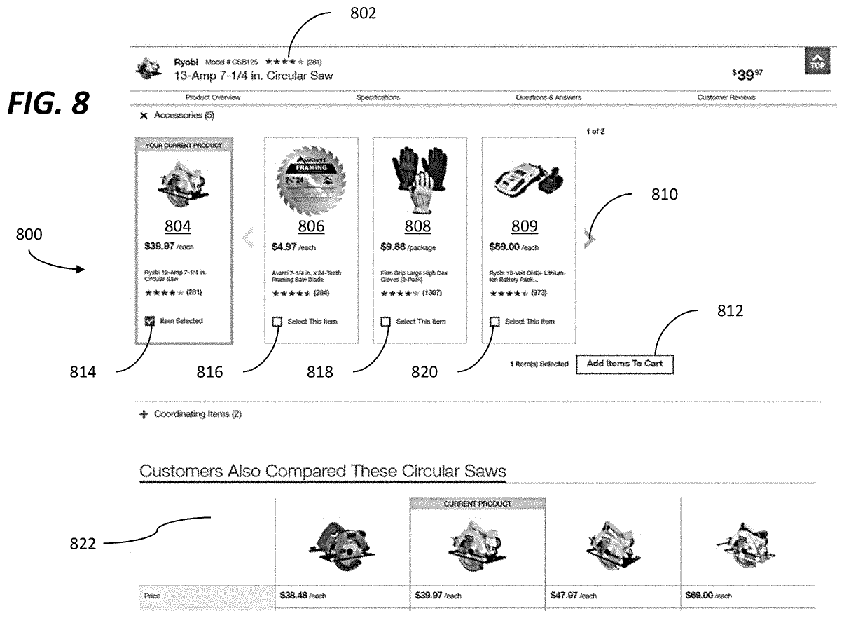

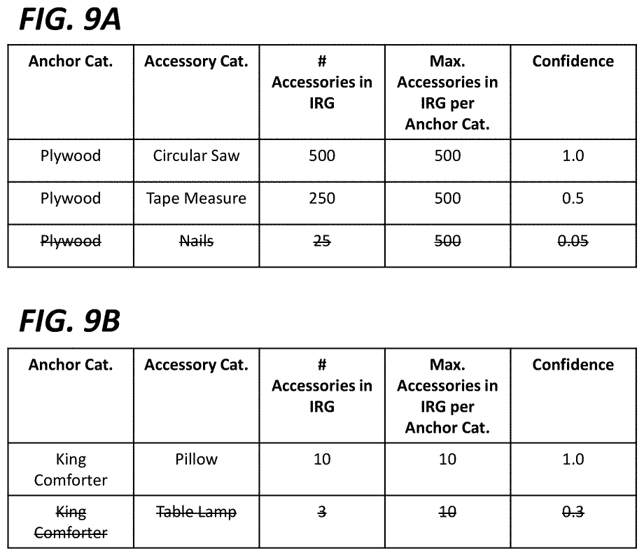

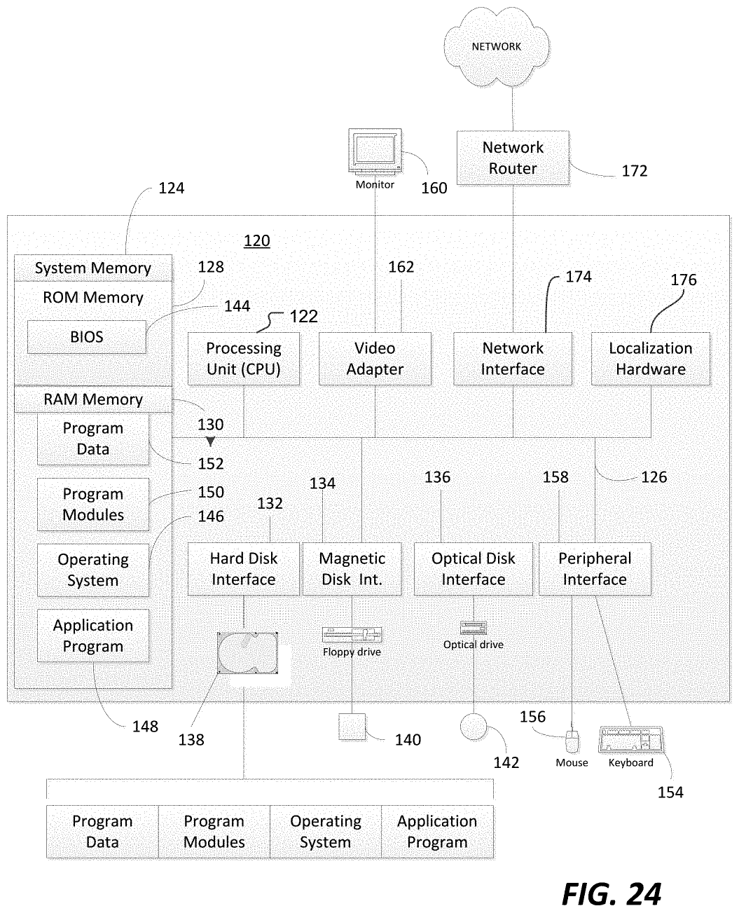

First, with respect to FIGS. 1 and 2, an example method and example system for providing product recommendations will be described at a high level. With respect to FIGS. 3-7, various embodiments for building lists of anchor-accessory relationships between products will be described. With respect to FIG. 8, an example graphical representation of displaying an anchor product along with multiple accessory recommendations to a user will be described (e.g., according to the method of FIG. 1). With respect to FIGS. 9A, 9B, 10A-10C, 11A-11C, 12A, 12B, 13A-13C, and 14-23, various tables and other figures demonstrate specific examples of determining accessory recommendations according to various methods will be described (e.g., according to the methods described in FIGS. 3-7). Finally, with respect to FIG. 24, an illustrative computing environment that may be used in conjunction with the methods and processes of this disclosure will be described.

Reference will now be made in detail to embodiments of the invention, examples of which are illustrated in the accompanying drawings. FIG. 1 is a flow chart illustrating an example method 100 of providing accessory item recommendations to a user. FIG. 2 is a block diagram view of a system 200 for providing accessory item recommendations to a user. The method 100 of FIG. 1 and the system 200 of FIG. 2 are described in conjunction below.

Generally, the method 100 may include receiving a selection of a product from a user electronic device and presenting recommended accessory products based on the user-selected product. A product selected by a user, with which accessory recommendations may be provided according to the various embodiments described herein, may be referred to herein as an anchor product or anchor item. The accessory recommendations may include items that are complementary with the anchor product. For example, a complementary accessory product may work with the anchor product, be compatible with the anchor product, and/or improve the utility of the anchor product when the anchor and accessory products are used in combination with one another. In some embodiments, the anchor-accessory relationship may be a one-way relationship. As just one example, a paintbrush may be considered an accessory of paint, but the paint would not be considered an accessory of a paintbrush. As another example, a saw blade may be an accessory of a saw anchor product, but the saw would not be an accessory of a saw blade product. As another example, a lightbulb may be an accessory of a lamp, but the lamp would not be an accessory of the lightbulb. That is, in some embodiments, there is a hierarchy or one-way nature to anchor-accessory relationships.

The system 200 generally includes computer hardware and functional capability for carrying out the method 100 and other methods and functions of this disclosure. The system 200 may include a transactions database 202, an item related group (IRG) database 204, a catalog database 206, an anchor-accessory processing system 208, an anchor-accessory relationship database 214, and a server 210 in electronic communication with a plurality of user devices 212₁, 212₂, . . . 212_{N}, which may be referred to individually as a user device 212 or collectively as user devices 212. The system 200 may also perform other methods of this disclosure and may provide one or more electronic user interfaces and/or graphical presentations of this disclosure. The system 200 may also host or otherwise provide one or more websites, mobile applications, and the like described in this disclosure, in embodiments. The system 200 may also store, host, or otherwise provide the anchor-accessory relationship database 214. In some embodiments, the anchor-accessory relationship database 214 may include or be a lookup table (LUT). Specific anchor-accessory product relationships determined according to the methods and systems described herein may be stored in the anchor-accessory relationship database 214. The anchor-accessory product relationships determined according to the methods and systems described herein may also be stored along with manually entered anchor-accessory product relationships in the anchor-accessory relationship database 214. In various embodiments, the anchor-accessory relationships that are manually entered (e.g., from the IRG database 204) may also be stored in or along with the anchor-accessory relationship database 214). In this way, according to various embodiments, accessory recommendations for various anchor products may be looked up in the anchor-accessory relationship database 214 and provided to a user through the server 210 to, for example, an interface of one of the user devices 212. The user devices 212 may be used by a customer to whom accessory recommendations are made and purchases may be made, by an employee of a retailer, by an employee of a merchant/supplier/manufacturer, a contractor of any of the aforementioned parties, or any other person who may be recommended an accessory, give feedback on the system or recommendations, configure the system, etc.

Providing accessory recommendations to a user according to the present disclosure may allow a user to more quickly view and purchase numerous items. For example, accessory recommendations may be provided to a user along with an anchor product selected by the user, and the user may purchase both the selected product and the recommended accessory product(s) with a reduced number of clicks. In various embodiments, graphical control elements may be provided that enable the user to select and purchase the anchor product and the recommended accessory product(s) from a single page or interface portion, thereby reducing user time and effort by eliminating the need for the user to separately navigate to the product page of each recommended accessory product(s). As a result, providing accessory product recommendations according to the techniques of the present disclosure solves an internet-centric problem-streamlining user interaction with a website or other electronic user interface-through methods and systems necessarily rooted in computer technology. Additionally, the techniques described herein provide improved functioning of a website accessed by a user. For example, according to the various techniques described herein, a database or lookup table of relationships between various anchor products and accessory products can be built before a user accesses the website and selects an anchor product to view and potentially purchase. Because the database or lookup table of relationships is already established, the accessory products related to a selected anchor product can be looked up in the database or lookup table and populated on the website for viewing and potential purchase by the user. Using such techniques, the accessory products can be looked up and loaded onto the website interface viewed by the user faster than if an anchor-accessory relationship was determined in response to a user selecting an anchor product to purchase. In other words, an accessory may be determined based on an anchor product by looking up an anchor-accessory relationship in a database or lookup table. E-commerce websites can occasionally have delays in page loads for potential customers, or even be unavailable during high traffic times (e.g., during a large sale). Accordingly, having data that will be sent to the users (e.g., accessory recommendations for a selected anchor product) be more readily available in a database or lookup table may allow more users to access an e-commerce website at one time, improve page load speeds for those users, and help prevent instances of users being unable to access the e-commerce website completely. Even when a page merely loads slow, a user may grow tired of waiting and move on to another website, and the e-commerce website therefore may lose a potential customer. Thus, the systems and methods described herein provide for a smoother working website that advantageously prevents a user from navigating away to another website and reduces the workload of one or more servers providing the website. However, in various embodiments, an accessory recommendation may still be made in real-time instead of selected from a predetermined database or lookup table.

The method 100 will be described in terms of a user, such as a customer, interacting with a website. The server 210 may host or provide that website, and accordingly may receive input from the user through the website. The server 210 may exchange information with the anchor-accessory processing system 208 and/or the anchor-accessory relationship database 214 to carry out one or more steps of the method, in embodiments. In other embodiments, the server 210, the anchor-accessory processing system 208, and anchor-accessory relationship database 214 may be the same processing system or apparatus.

The method 100 may be performed, in part or in full, by a retailer, in embodiments. That is, the system 200 may be owned or operated by or on behalf of a retailer, in embodiments. The method 100 may also be carried out, in full or in part, by some other type of entity. A website having the features referenced herein may be the website of a retailer, and the brick-and-mortar stores referenced herein may be stores of the same retailer. Additionally or alternatively, a website having the features described herein and the brick-and-mortar stores may be associated with different entities. A website having the features described herein may list and sell items sold by the retailer, in embodiments. Additionally or alternatively, such a website may list and sell items sold by third parties.

The method 100 may include an operation 102 of building anchor-accessory product relationship lists between items. These anchor-accessory product relationships may be determined according to the methods and systems described herein, for example according to the various embodiments described throughout herein and with respect to FIGS. 3-23. One or more the embodiments described herein may be utilized to build the lists. The lists may also include manually entered anchor-accessory product relationships. The anchor-accessory product relationships may be determined using the methods described herein by the anchor-accessory processing system 208 and stored in the anchor-accessory relationship database 214. In this way, the server 210 can access the lists of anchor-accessory product relationships.

With continued reference to FIGS. 1 and 2, the list building operation 102 may generally include the anchor-accessory processing system 208 utilizing records of transactions in the transaction database 202 to determine, for example, co-purchase data that indicates how often products are bought together, mean spend data, or any other type of data related to transactions. Examples of transaction data being utilized to determine anchor-accessory relationships are described herein, such as at least with respect to FIGS. 3, 7, 10A-10C, 11A-11C, and 19-23.

The list building operation 102 may also generally include the anchor-accessory processing system 208 utilizing an item related group (IRG) database 204. The IRG database 204 may include manually entered anchor-accessory product relationships. For example, particular items may be associated with stock keeping units (SKUs) that are typically unique alphanumeric sequences assigned to unique products for managing inventory. The IRG database 204 may include manually entered anchor-accessory product relationships between specific SKUs. These may be relationships that are entered one at a time by a user, a retailer, and/or a vendor/supplier/manufacturer of a product. For example, a flashlight manufacturer may designate battery accessory recommendations, which can be sent to a retailer of the flashlights and stored in the IRG database 204. In other examples, the manufacturers, suppliers, or any other party may have access to add or adjust anchor-accessory relationships in the IRG database 204. In this way, an accessory product may be determined for the anchor product by looking up the anchor product SKU in the IRG database 204 to find an accessory recommendation for that anchor product. However, some anchor product SKUs may not be associated with an accessory recommendation in the IRG database 204. Accordingly, the various systems and methods described herein may be utilized by the anchor-accessory processing system 208 to determine accessory recommendations for products that do not have a recommendation in the IRG database 204 (or may be utilized to determine additional accessory recommendations for products that already have at least one recommendation in the IRG database 204). In various embodiments, the anchor-accessory processing system 208 may utilize recommendations already in the IRG database 204 to help determine new anchor-accessory relationships (e.g., an accessory recommendation for an anchor product). Some examples of utilizing the IRG database 204 to determine anchor-accessory relationships and/or recommendations are described herein at least with respect to FIGS. 3, 6, 7, 9-11, and 16-23.

The list building operation 102 may also generally include the anchor-accessory processing system 208 utilizing a catalog database 206. The catalog database 206 includes information about various products, including product names, product descriptions, SKUs, attributes, and any other information about a product. Such information may be utilized by the anchor-accessory processing system 208 to determine anchor-accessory relationships. For example, product compatibility may be determined by the anchor-accessory processing system 208 based on information from the catalog database 206. For example, the anchor-accessory processing system 208 may utilize information from the catalog database 206 to determine which light bulbs are compatible with a particular light fixture or lamp. In various embodiments, information from the catalog database 206 may also be utilized by the anchor-accessory processing system 208 to determine product categories of various products. For example, information in the catalog database 206 may be utilized to determine that particular SKUs are part of a product category (e.g., flathead screwdriver is part of a screwdriver product category or hand tool product category, two-by-four untreated lumber is part of a lumber product category, etc.). Some further examples of utilizing product information, for example from the catalog database 206, to determine anchor-accessory relationships is described herein with respect to FIGS. 3-7 and 9-23.

The list building operation 102 may also generally include anchor-accessory product relationships being determined using the methods described herein by the anchor-accessory processing system 208. For example, the anchor-accessory processing system 208 may determine, create, and/or use compatibility rules 218 according to the various methods described herein. For example, the compatibility rules 218 may be utilized by the anchor-accessory processing system 208 to determine which products are compatible with one another for determining anchor-accessory relationships. The compatibility rules 218 may be received from a vendor/supplier/manufacturer of a product, a retailer, a purchaser/customer of a product, etc. The compatibility rules 218 may be adjusted over time based on feedback (e.g., feedback on whether the rules produce good and/or meaningful accessory recommendations). The feedback may, for example, be received from one of the user devices 212.

The compatibility rules 218 may include, for example, attribute matching rules. The attribute matching rules may be used to determine that attributes of an anchor product and a potential accessory product match. For example, with lighting, attributes of a lighting fixture including bulb wattage, light bulb shape, light bulb base code, and/or light bulb style may be attributes that a light bulb should match to recommended as an accessory for the anchor lighting fixture.

The compatibility rules 218 may have a required/optional designation, indicating whether a particular attribute must match for the accessory to be recommended (required) or whether the particular attribute need not match for the accessory to be recommended (optional). For example, with the light fixture and light bulb, a light bulb base code may be required to match so that the light bulb will actually fit into the light fixture, while the light bulb style may merely be optional for a light bulb to be recommended as an accessory.

The compatibility rules 218 may also utilize a matching logic parameter because different attributes may match in different ways. For example, referring again to the light fixture and light bulb, the matching logic parameter for the light bulb base code may be that the base code for the light bulb and the light fixture be equal. If the base codes associated with both the fixture and the bulb are not equal, the light bulb may not fit into the fixture (and the two are therefore not compatible and the bulb should not be recommended as an accessory for the fixture). In contrast, a wattage rating for a light fixture typically indicates the maximum wattage a bulb should be when used with that fixture. Thus, a matching logic parameter for bulb wattage may be an equal to or larger than parameter, meaning that the maximum bulb wattage rating for a light fixture should be equal to or larger than the wattage of a bulb for the system to determine compatibility between a light fixture and bulb.

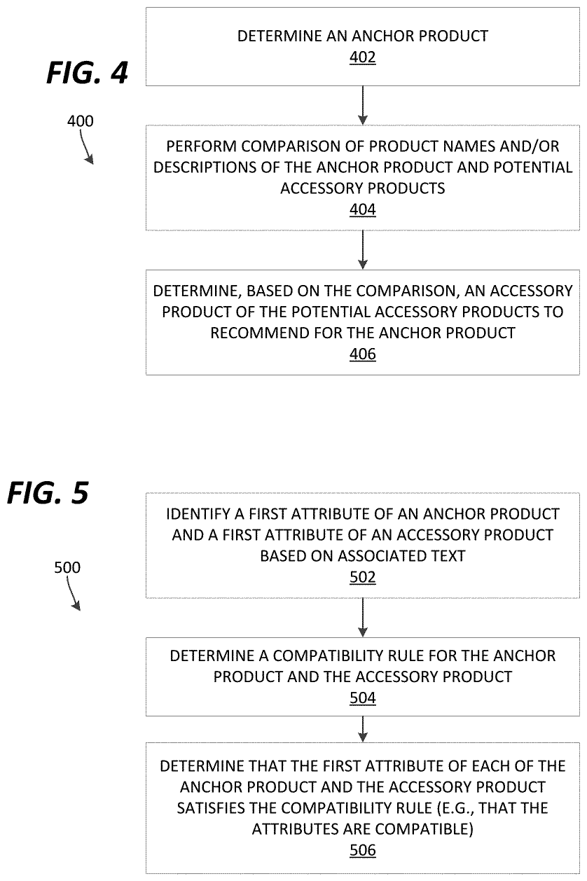

The compatibility rules 218 may also use sorting criteria for making accessory recommendations. In other words, certain criteria may be prioritized higher than others when determining an accessory recommendation. As just one example, a manufacturer of a bulb may rank as a more important criterion to match for an accessory recommendation than a number of bulbs included in a product package. In some embodiments, the criteria that are prioritized may be only optional attributes. That is, in some embodiments, to successfully make an accessory recommendation, all required attributes must be met, and some or all optional attributes may be prioritized in a certain order to determine accessory recommendations. If a higher priority optional attribute for two potential accessory products is the same (a tie), the system may check lower priority attributes until a recommendation is determined (e.g., break the tie based on lower priority optional attributes). In various embodiments, the compatibility rules 218 may be used, for example, in the various methods and systems discussed herein with respect to FIGS. 4, 5, 7, and 13-15.

The anchor-accessory processing system 208 may further determine, create, and/or use attribute classification parameters 220 according to the various methods described herein. For example, the attribute classification parameters 220 may be utilized by the anchor-accessory processing system 208 to determine which products are compatible with one another for determining anchor-accessory relationships. The attribute classification parameters 220 may be received from a vendor/supplier/manufacturer of a product, a retailer, a purchaser/customer of a product, etc. The attribute classification parameters 220 may be adjusted over time based on feedback (e.g., feedback on what the attributes should be looked for, feedback on whether the system is accurately classifying certain data as attributes, etc.). The feedback may, for example, be received from one of the user devices 212.

The attribute classification parameters 220 may be used in combination with the compatibility rules to determine anchor-accessory relationships/recommendations as described herein. For example, the anchor-accessory processing system 208 may analyze information from the catalog database 206 to determine attributes of certain products. Those attributes may be identified based on attribute classification parameters 220. The catalog database 206 may include attribute classifications that are easily identifiable according to the attribute classification parameters 220 (e.g., light bulb base code, color, bulb wattage, nail length, nail width, nail material, nail head size, etc.).

In some embodiments, the attributes of certain products may not be easily apparent based on the information in the catalog database 206. For example, certain products may describe an attribute in a product description narrative, rather than in a separately delineated or labeled attribute listing. In such embodiments, the system may identify attributes based on the attribute classification parameters 220, which instruct what to look for in order to identify attributes of various products. For example, in some instances, an attribute of a product may be inferred from a product description instead of being explicitly defined. In other examples, a product may have one or more attributes that are not relevant to determining product compatibility. For example, the color of certain products may not be relevant for determining an accessory recommendation.

The attribute classification parameters 220 may also be utilized not only to identify an attribute, but the attribute value as well. For example, if the identified attribute is nail length, the attribute classification parameters 220 may also be utilized to identify the value of that attribute for a given product. In this example, the expected value for a nail length, according to the attribute classification parameters 220, will be a distance measurement (e.g., one-fourth of an inch, 1 inch, 5 centimeters, etc.). The attribute classification parameters 220 can therefore advantageously be used to more accurately identify both attribute and attribute values of products based on information from the catalog database 206. Accordingly, the attribute classification parameters 220 may include parameters that instruct the anchor-accessory processing system 208 to look for attributes and attribute values that are relevant for determining anchor-accessory relationships.

The anchor-accessory processing system 208 may further determine, create, and/or use product category determinations 222 according to the various methods described herein. For example, the product category determinations 222 may be utilized by the anchor-accessory processing system 208 to determine anchor-accessory relationships (which can be used for making accessory recommendations as described herein throughout). The product category determinations 222 may be received from a vendor/supplier/manufacturer of a product, a retailer, a purchaser/customer of a product, etc. The product category determinations 222 may also be indicated by information in the catalog database 206, the IRG database 204, the transaction database 202, or any other database that indicates which product category specific SKUs are a part of. The product category determinations 222 may be adjusted over time based on feedback. The feedback may, for example, be received from one of the user devices 212.

Product categories may be utilized according to various embodiments described herein. For example, a particular item or SKU may be considered an anchor product. An accessory product may be determined for the anchor product by determining what product category the SKU is part of to find products similar to the anchor product. That product category of the anchor product and similar products may be made according to the product category determinations 222. As just one example, the product category determinations 222 may indicate that the SKU for a flathead screwdriver is similar to or in the same product category as other screwdriver products/SKUs. That is, the product category determinations 222 may include information on what category each SKU is a part of. The anchor-accessory processing system 208 can then check to see if other screwdrivers in the product category already have an anchor-accessory relationship, which can be used to determine an accessory product recommendation for the flathead screwdriver SKU according to various methods described herein. Accordingly, the product category determinations 222 can assist in building anchor-accessory relationships.

If the product category determinations 222 do not include information on what category a certain product is in, the anchor-accessory processing system 208 may determine a product category for a SKU or group of SKUs and store that information as part of the product category determinations 222 so that it can be used to determine anchor-accessory relationships going forward. Some examples of utilizing the product category determinations 222 to determine accessory recommendations are described herein at least with respect to FIGS. 3, 6, 7, 9-11, and 16-23.

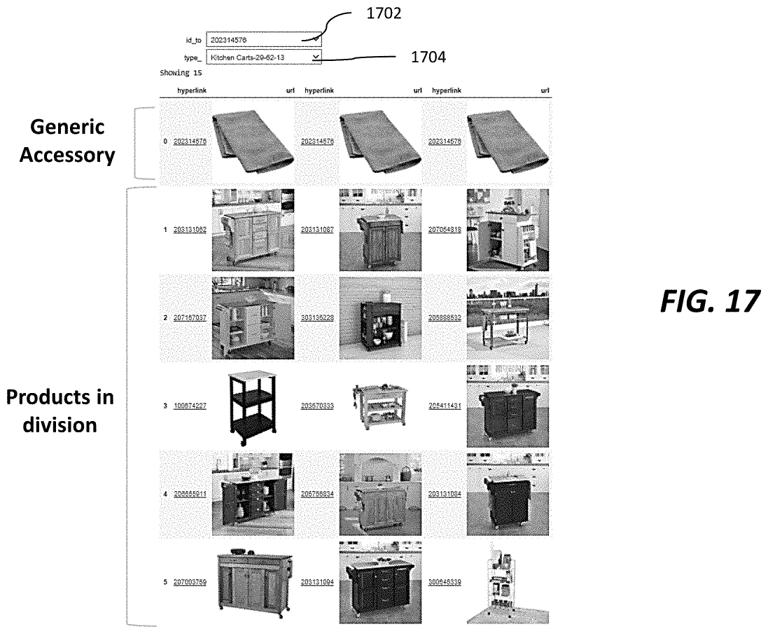

The anchor-accessory processing system 208 may further utilize a visual validation module 224 according to the various methods described herein. For example, the visual validation module 224 may be utilized in combination with the user devices 212 by the anchor-accessory processing system 208 to determine anchor-accessory relationships and/or optimize existing anchor-accessory relationships. In particular, the visual validation module 224 may be utilized to provide an interface through which feedback on existing anchor-accessory relationships can be given. For example, users accessing the interface through the user devices 212 may indicate whether an anchor-accessory relationship stored in the anchor-accessory relationship database 214 is good, bad, neutral, etc. The visual validation module 224 may also be used to provide an interface for providing feedback on other aspects of the anchor-accessory processing system 208, such as the compatibility rules 218, the attribute classification parameters 220, the product category determinations 222, manually entered anchor-accessory relationships in the IRG database 204, and/or any other aspect of the methods and systems described herein. One example of an interface that may be displayed on one of the user devices 212 by the visual validation module 224 is described herein with respect to FIG. 17.

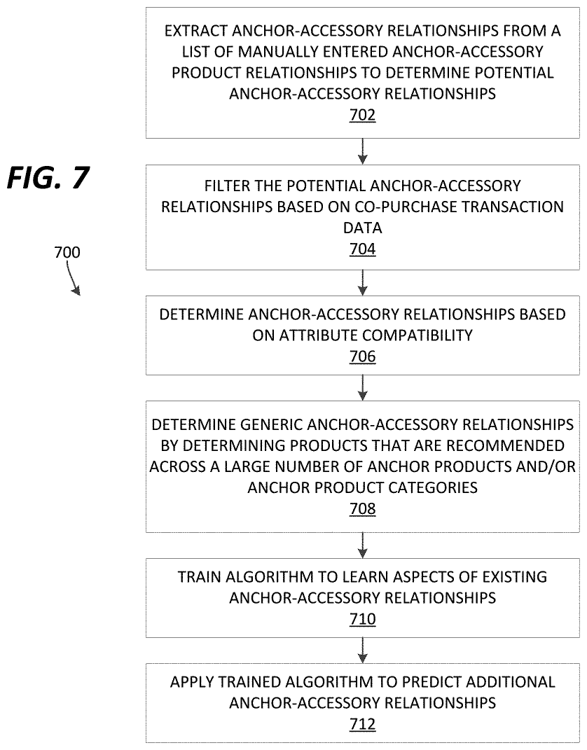

The anchor-accessory processing system 208 may further utilize an algorithm training module 226 according to the various methods described herein. For example, the algorithm training module 226 may be utilized to train an algorithm that automatically identifies, creates, or defines new anchor-accessory relationships to save in the anchor-accessory relationship database 214. The algorithm training module 226 may be trained using various factors, data, sources of information, etc. to learn about existing anchor-accessory relationships stored in the anchor-accessory relationship database 214 and/or the IRG database 204. Once the algorithm is trained, the algorithm can use the same factors, data, sources of information, etc. can then be used to determine anchor-accessory relationships for products that do not have anchor-accessory relationships (or for products for which more anchor-accessory relationships are desired). Accordingly, the algorithm training module 226 may incorporate data from various sources for training (and subsequently the anchor-accessory processing system 208 may incorporate data from various sources when using the trained algorithm to determine new anchor-accessory relationships). For example, the transaction database 202, the IRG database 204, the catalog database 206, the compatibility rules 218, the attribute classification parameters 220, the product category determinations 222, and/or any other data source may all to varying extents be used to train an algorithm and use the algorithm to determine new anchor-accessory relationships. Examples of training and utilizing an algorithm are described herein with respect to FIGS. 7 and 19-23.

In various embodiments, a text mining module 228 may also be utilized to determine anchor-accessory relationships by the anchor-accessory processing system 208. The text mining module 228 may be used in combination with other aspects of the anchor-accessory processing system 208, such as the compatibility rules 218, the attribute classification parameters 220, the product category determinations, and/or the algorithm training module 226. The text mining module 228 can be used to mine, compare, identify, or otherwise analyze text relating to products that may be useful for determining anchor-accessory relationships. For example, the text mining module 228 may mine product descriptions from the catalog database 206 that are useful for determining compatibility rules 218, attributes of products, determining product categories, determining new or different attribute classification parameters, etc. In another example, the text mining module 228 may be utilized to identify text that is useful for training an algorithm with the algorithm training module 226 or to identify text that is useful for utilize an already trained algorithm.

Accordingly, as described herein throughout, the transaction database 202, the IRG database 204, the catalog database 206, the anchor-accessory processing system 208 (which includes the compatibility rules 218, the attribute classification parameters 220, the product category determinations 222, the visual validation module 224, the algorithm training module 226, and the text mining module 228), or any combination thereof may be utilized to build lists of anchor-accessory relationships according to the operation 102 of the method 100 shown in FIG. 1. These anchor-accessory relationships may be stored in the anchor-accessory relationship database 214, which can be accessed by the server 210 to provide accessory recommendations to the user devices 212 as further discussed below.

With continued reference to FIGS. 1 and 2, the method 100 may further include an operation 104 of receiving a selection of an anchor product from a user. The selection may be received, for example, by the server 210 from a user device 212 through a website or through another electronic user interface such as a mobile application, in-store kiosk, etc. As noted above, the website may be, for example, an e-commerce site associated with or operated by or on behalf of a retailer. The selection may be, for example only, a click on the anchor product on a page of the website, navigation to a product information page of the anchor product on the website, a user action to add the anchor product to the user's shopping cart on the website, etc.

In an embodiment, a selection of an anchor product at the operation 104 may be received from a user through a voice search or request through the electronic user interface. For example, the electronic user interface with which the user interacts may be on a mobile application, and the mobile application may be configured to capture voice search requests from the user. The server 210 or user devices 212 may be configured with voice recognition software to parse the user's voice search or voice request to determine an anchor product. In response to the voice search, voice request, or other type of search or request, the server may provide one or more accessory recommendations to the user for the anchor product through the electronic user interface, as described below.

In another embodiment, a selection of an anchor product may be received from a user through a text-based (e.g., SMS or MMS) request. For example, the user may transmit a text message order for an anchor product from one of the user devices 212 and, in response, the server 210 may transmit one or more accessory recommendations to the user device 212 from which the request originated.

The method 100 may further include an operation 106 of determining one or more accessory items that are related to an anchor product as described herein to recommend to the user for purchase along with the anchor product. The operation 106 may include determining or looking up anchor-accessory relationships that have been previously determined and saved in the anchor-accessory relationship database 214. In this way, accessory recommendations may be made quickly and sent to the user device 212 that has selected an anchor product for viewing and/or purchase because the system does not have to determine a new accessory recommendation. That is, the lists of anchor-accessory relationships have already been built at the operation 102 and stored in the anchor-accessory relationship database 214 for quick lookup. This can cause a webpage at the user device 212 with the accessory recommendation to load faster than if the anchor-accessory processing system 208 determined one or more accessory recommendations after the selection of the anchor product from the user device 212 is received at the operation 104. However, in various embodiments, the anchor-accessory processing system 208 may determine one or more accessory recommendations after the selection of the anchor product from the user device 212 is received at the operation 104. Either way, the server 210 can determine the accessory recommendation by retrieving or looking up an anchor-accessory relationship in the anchor-accessory relationship database 214 or receive from the anchor-accessory processing system 208 the one or more accessory to recommend. In some embodiments, where more than one accessory recommendation is made for an anchor product, one or more accessory recommendation may be looked up or retrieved from the anchor-accessory relationship database 214 and one or more accessory recommendation may be received from the anchor-accessory processing system 208, which can determine accessory recommendations according to the various methods described herein.

The method 100 may further include an operation 108 of presenting the one or more accessory recommendations for purchase along with the anchor product on the electronic user interface, such as on an interface of the user device 212. The accessory items may be presented, for example, on the website adjacent to a listing of the anchor item. In embodiments, where the anchor item is selected by the user via the user's navigation to a product information page of the anchor item, the accessory items may be presented on the anchor item's product information page. The accessory items may be presented in conjunction with one or more graphical control elements that enable the user to select the accessory items and/or anchor item for purchase, singularly or in combination. The graphical control elements may enable the user to purchase the items by initiating a purchase (e.g., adding to cart) or by completing a purchase (e.g., checking out, performing a 1-click purchase, etc.), in embodiments. One example of a user interface, for example presented on a website on the user device 212, is shown in FIG. 8.

The method 100 advantageously provides accessory product recommendations to customers on a website and allows the customers to purchase recommended accessory products with a reduced number of clicks. Instead of separately selecting and separately navigating to a product information page of each of the recommended accessory items, the method 100 provides a quicker way for the customer to purchase the anchor product and the accessory item(s).

As will be detailed below, the presenting operation 108 may include presenting a graphical display of additional items that are recommended accessories along with the user-selected anchor product without additional website navigation by the user. For example, the accessory products may be displayed on or over a product information page so that, from the product information page of the anchor product, the user can add the anchor product and one or more of the recommended accessory items to the user's cart. In addition to, or instead of, providing the accessory product recommendations on the product information page of the anchor product, accessory product recommendations may be provided in a web page showing the user's cart, on a product search page, or otherwise.

The user noted in the various methods described herein may be a customer that is shopping on a website provided by the server 210 with a user device 212, in embodiments. The user device 212 may be a personal computer, user mobile computing device, or other computing device. Additionally or alternatively, the server 210 may provide all or part of an in-store checkout or informational environment or digital price display information, and the user devices 212 may be in-store kiosks or digital price displays. Additionally or alternatively, accessory recommendations may be provided through an augmented reality interface, virtual reality interface, smart home device (e.g., television, refrigerator), electronic audio assistant (e.g., Amazon Echo™, Google Home™, Apple's Siri™), or any other interface through which an accessory recommendation may be presented to a user.

FIG. 3 is a flow chart illustrating an example method 300 of determining an accessory product to recommend to a user based on a list of manually entered anchor-accessory product relationships, in embodiments. The method 300 may be utilized, for example, to build lists of anchor-accessory relationships between products/items, such as in the operation 102 of the method 100 in FIG. 1. The method 300 may also be performed by the anchor-accessory processing system 208 to provide accessory recommendations to the user devices 212 through the server 210 and/or to store anchor-accessory relationships in the anchor-accessory relationship database 214 as described herein. FIGS. 9A and 9B are tables showing example criteria for selecting accessory products based on a list of manually entered anchor-accessory product relationships, in embodiments.

In an operation 302, an anchor product category of an anchor product is determined. The anchor product may be a product selected for viewing or purchase by a user as described herein (e.g., at the operation 104 of FIG. 1). In various embodiments, the anchor product may not be selected by a user yet, but the system is determining accessory recommendations for various anchor products to be stored in a database or lookup table, such as in the anchor-accessory relationship database 214. The anchor product is a particular product associated with a unique SKU. The anchor product category is a category of many particular products that are each associated with a SKU. For example, two-by-four pine lumber is a particular product that may be part of a two-by-four or lumber product category. In the example of FIG. 9A, the anchor product category determined is plywood. In the example of FIG. 9B, the anchor category determined is king comforters. The product category may be determined, for example, based on previous product category determinations 222 by the anchor-accessory processing system 208 of FIG. 2. The product category may also be determined, for example, based on information in the catalog database 206 of FIG. 2. For example, the catalog database 206 may already have products arranged in categories, or information in the catalog database 206 may be utilized by the anchor-accessory processing system to determine a product category associated with an anchor product.

In an operation 304, other anchor products that are in the anchor product category are determined. In other words, the system determines other particular products in the same product category as the anchor product. For example, a lumber product category may include lumber of various sizes, types, treatments, etc. In the example of FIGS. 9A and 9B, other plywood and king comforter SKUs are determined, respectively, according to the operation 304.

In an operation 306, based on the other anchor products, accessory products from a list of manually entered anchor-accessory product relationships that are recommended for the other anchor products are determined. In other words, accessory recommendations of the other anchor products in the anchor product category are found in the list of manually entered anchor-accessory products. The list of manually entered anchor-accessory product relationships may, for example, be the IRG database 204 of FIG. 2. These accessory products may be utilized to determine/select an accessory product to recommend with the anchor product (e.g., what accessory to store along with the anchor as an anchor-accessory relationship). That selection may occur for example, at an operation 314 described below. Other operations, such as one or more of operations 308, 310, and/or 312, may be additionally be performed to determine which of the plurality of accessory products to select as a recommended accessory for a given anchor product.

In various embodiments, other sources of anchor-accessory product relationships may be used instead of or in addition to a list of manually entered anchor-accessory product relationships. For example, other sources of information may be leveraged to determine a list of anchor-accessory product relationships. Other sources may include, by way of example, constructor/assembly/maintenance manuals (e.g., a car manual describing which mats are compatible with the vehicle, a refrigerator manual describing which filters work with the refrigerator). Other sources of information may be unstructured, such as public blogs, product reviews, forums, etc. For example, a blogger may publish a post on the internet describing their use of a product and accessories they successfully used with the product. This information may be mined to assemble a list of anchor-accessory product relationships. In another example, a product review for a particular product may describe other items that may be used as an accessory with the product, or may items for which the particular product may be an accessory. This information may also be mined to assemble a list of anchor-accessory product relationships.

In an operation 308, accessory product categories may be determined, where each of the accessory products is in at least one of the accessory product categories. In other words, the system determines product categories for each of the accessory products that are recommended for the anchor products in the anchor product category. This information (what categories the accessory products are part of) can inform how to select an accessory recommendation for the anchor product because the anchor product is in the same category as the plurality of anchor products. For example, with lumber as an example anchor product category, accessory product categories may include various product categories such as circular saws, tape measures, nails, etc. Because a list of manually entered anchor-accessory relationships (e.g., the IRG database 204) may include anchor-accessory relationships between specific SKUs, the operation 308 can be utilized to determine what categories of products are being recommended as an accessory for a particular anchor product category. In the example of FIG. 9A, the accessory categories determined are circular saws, tape measures, and nails. In the example of FIG. 9B, the accessory categories determined are pillows and table lamps. Examples of how these determined plurality of accessory product categories may be used are further described with respect to FIGS. 9A and 9B. Accessory product category determinations may be made, for example, according to information from the catalog database 206 and/or the product category determinations 222 of FIG. 2.

In an operation 310, a respective number of instances, for each of the accessory product categories, in which any of the accessory products is recommended for the anchor product category in the list of manually entered anchor-accessory product relationships is determined. In other words, the system determines how many times an accessory of a particular accessory product category is recommended for any anchor product of a particular anchor product category. For example, referring to the example shown in the table in FIG. 9A, circular saws (an accessory product category) were recommended as an accessory for plywood (an anchor product category) 500 times. Thus, the number of instances in which the circular saw accessory products were recommended for the plywood is 500. Further in the example of FIG. 9A, accessories in the product category of tape measures were recommended for plywood 250 times, while accessories in the product category of nails were recommended 25 times. Accordingly, these number of instances that an accessory product category is recommended may be used to determine an accessory recommendation for an anchor product in the plywood category that may not have an associated accessory recommendation (or may not have as many recommended accessories as desired). One or more of a circular saw, tape measure, and/or nails may therefore be recommended for a particular plywood SKU based on the determination made in the operations 308 and 310.

Such recommendations may be made based on a frequency or other factor of the number of instances determined. For example, accessory product categories that are recommended more often may be utilized to make an accessory recommendation for an anchor product (e.g., select the accessory product to recommend at the operation 314). For example, selecting the accessory product to recommend for the anchor product may include selecting from one of the plurality of accessory products that is in one of the plurality of accessory product categories that has the number of instances above a predetermined number or that has the number of instances as a percentage of a total number of products in the anchor product category above a predetermined percentage. In various embodiments, one or both criteria may be used with respect to the number of instances to determine which accessory category to select an accessory recommendation from.

FIG. 9B shows an example of using the number of instances being above a threshold (e.g., predetermined value) as the criterion for selecting which accessory category to use for recommending an accessory. For example, the predetermined number may be five (5) recommendations. A product from the pillow accessory category is recommended for the king comforter anchor product category ten (10) times, thus a pillow accessory may be recommended as an accessory for a king comforter. In contrast, a table lamp is only recommended for the king comforter products three (3) times. Thus, the table lamp category may not be used when the criterion of the number of instances being above a predetermined number is utilized (because three is below the predetermined threshold number of five).

FIG. 9A shows an example of using the number of instances as a percentage of a total number of products in the anchor product category above a threshold (e.g., a predetermined percentage) as the criterion for selecting which accessory category to use for recommending an accessory. In various embodiments, this may be referred to as using a confidence ratio. In FIG. 9A, circular saws have been recommended five hundred (500) times, tape measures two hundred fifty (250) times, and nails twenty-five (25) times. There are five hundred (500) total anchor products (plywood SKUs) in the list of manually entered anchor-accessory relationships. Accordingly, in this example, circular saws were recommended 100% of the time (a confidence ratio of 1.0), tape measures were recommended 50% of the time (a confidence ratio of 0.5), and nails were recommended 5% of the time (a confidence ratio of 0.05). Accordingly, the predetermined percentage may be used to determine which of the accessory categories are utilized to make an accessory recommendation. For example, a minimum percentage of 10% (or confidence ratio of 0.1) may be used as the predetermined number. In such an example, the nails accessory category falls below and would not be used to make recommendation, while circular saws and tape measures may be recommended. If the minimum percentage was, for example, 60% (confidence ratio of 0.6), only circular saws would be utilized to select a recommendation for the plywood anchor product. In various embodiments, a system may also select recommendations based on which accessory product categories have the highest number of recommendations and/or percentages (confidence ratios), instead of or in addition to utilizing predetermined criteria. For example, this may be helpful if there are no accessory categories that meet predetermined criteria.

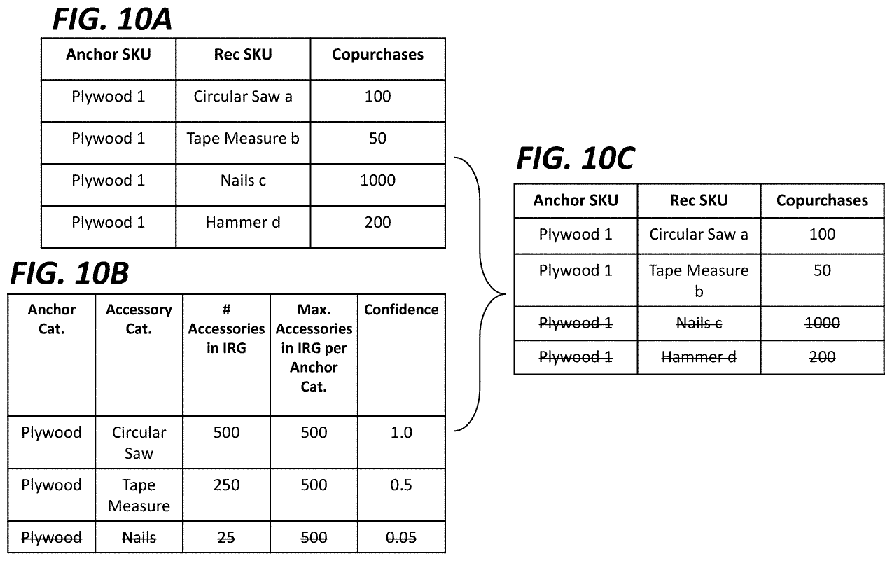

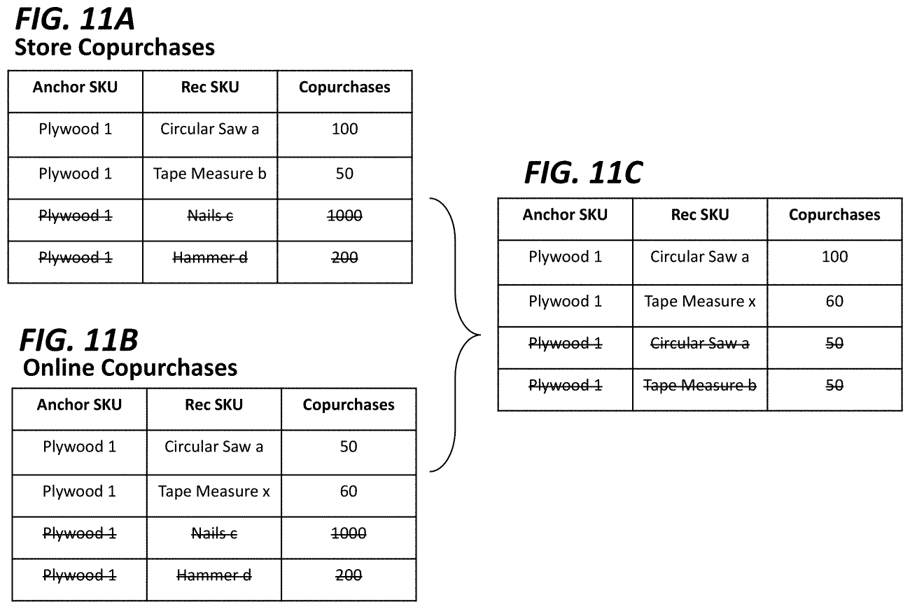

While an accessory product may be selected to be recommended for an anchor product (e.g., at the operation 314) based on the operations 306, 308, and/or 310, the accessory recommendation/selection may additionally or alternatively be based on an operation 312. Examples of the operation 312 will be discussed with reference to FIGS. 10A-10C and 11A-11C. FIGS. 10A-10C are tables showing an example of selecting accessory products based on a list of manually entered anchor-accessory product relationships and co-purchase data, in embodiments. FIGS. 11A-11C are tables showing an example of selecting accessory products based on in-store and online co-purchase transaction data, in embodiments.

In the operation 312, co-purchase data between the other anchor products in the anchor product category and the accessory products that are recommended for the other anchor products is determined. The co-purchase data may be determined, for example, by the anchor-accessory processing system 208 based on the transaction database 202. This co-purchase data may be used as described herein to further narrow possible selections for an accessory recommendation. For example, the system may determine at the operation 314 to recommend an accessory that was co-purchased with the anchor product a highest number of times. In another example, the system may determine at the operation 314 to recommend an accessory that was co-purchased with the plurality of other anchor products a highest number of times. In another example, the system may determine at the operation 314 to recommend an accessory that was recommended for one of the plurality of other anchor products and is in an accessory product category that meets other criterion, such as the percentage of times the category of accessory is recommended for the anchor product category (e.g., as described above with respect to FIG. 9A), or such as the number of times the category of accessory is recommended for the anchor product category (e.g., as described above with respect to FIG. 9B). Further examples of how co-purchase data as determined at the operation 312 may be utilized to determine an accessory recommendation are described below.

In the example of FIGS. 10A-10C, co-purchase data is filtered with the extracted accessory relationship information of FIG. 9A to pick the most co-purchased SKU for each accessory type. FIG. 10A shows co-purchase data between a “Plywood 1” SKU (i.e., a particular plywood product/SKU). The “Plywood 1” SKU has been purchased with “Circular Saw a” one hundred (100) times, with “Tape Measure b” fifty (50) times, with “Nails c” one thousand (1,000) times, and with “Hammer d” two hundred (200) times. In some embodiments, the accessory recommendation may be selected based on this co-purchase data, such as selecting the “Nails c” SKU because they were co-purchased with the “Plywood 1” SKU the most times. However, in the example of FIGS. 10A-10C, the co-purchase data is filtered utilizing the extracted accessory information from the operations 306, 308, and 310 to get even more meaningful recommendations. In other words, the co-purchase data and data from a manually entered list of anchor-accessory products is utilized along with the co-purchase data to make an accessory recommendation.

FIG. 10B shows the same data as FIG. 9A, where data from a manually entered list of anchor-accessory products was determined, and nails were excluded from consideration to be an accessory recommendation because it had a confidence ratio of less than 0.1. Accordingly, when filtering the co-purchase data of FIG. 10A with the determinations of FIG. 10B, the “Nails c” and “Hammer d” are eliminated from consideration for an accessory recommendation. Even though the “Nails c” and “Hammer d” had higher quantities of co-purchases, only circular saws and tape measures were recommended at a high enough frequency to be considered for accessory recommendations. Accordingly, as shown in FIG. 10C, the system at the operation 314 may select the “Circular Saw a” SKU and the “Tape Measure b” SKU to be specifically recommended for the “Plywood 1” SKU, because they had a high number of co-purchases and were part of an extracted accessory product category that were recommended a high number of times for other anchor products in the plywood anchor product category according to a manually entered list of anchor-accessory relationships. Other circular saw and/or tape measure SKUs may have been co-purchased with the “Plywood 1” SKU, but in this example “Circular Saw a” was co-purchased more than other circular saws (and likewise with “Tape Measure b”) so that is the data utilized when filtering based on the data in FIG. 10B and selecting specific products to recommend as shown in FIG. 10C.

In various embodiments, the system may also determine which of the plurality of accessory products has been co-purchased with the anchor product from co-purchase data that includes records of purchases through a website or mobile application and/or records of purchases in one or more brick-and-mortar stores. That is, both in-store and online co-purchase data may be utilized to determine the co-purchase data (e.g., the co-purchase data of FIG. 10A). FIGS. 11A-11C show an example of how both in-store and online co-purchase data may be utilized.

FIG. 11A shows an example of in-store co-purchase data, which is similar to the co-purchase data shown in FIG. 10A. FIG. 11B shows example online co-purchase data, which shows similar co-purchase data to FIG. 11A, except that “Circular Saw a” was only purchased with “Plywood 1” fifty (50) times, and “Tape Measure x” was purchased with “Plywood 1” sixty (60) times. Although “Tape Measure b” may still have been co-purchased with “Plywood 1” in online purchases, the “Tape Measure x” data point is included in FIG. 11B because “Tape Measure x” was co-purchased more times with “Plywood 1” than was “Tape Measure b.” The in-store co-purchase data and the online co-purchase may then be stacked and deduped, as shown in FIG. 11C. In particular, the “Circular Saw a” data is deduped to include only the in-store co-purchase data because there were more co-purchases in the in-store transaction data (100) than in the online co-purchase data (50). The tape measures are stacked to remove “Tape Measure b” in FIG. 11C because it was purchased less times (50) than “Tape Measure x” (60). In this way, only one accessory SKU (in this case “Tape Measure x”) from a given accessory product category may be recommended as an accessory for an anchor product (in this case the “Plywood 1” SKU), in embodiments. Accordingly, one or both of “Circular Saw a” and “Tape Measure x” may be selected at the operation 314 as accessories to recommend for the “Plywood 1” anchor product. In various embodiments, anchor-accessory relationships between the Plywood 1 and the Circular Saw a and/or “Plywood 1” and “Tape Measure x” may be stored in the anchor-accessory relationship database 214 for future lookup for determine accessory recommendations to send to the user devices 212.

In various embodiments, the in-store and/or online co-purchase data as shown in FIGS. 11A and 11B may also include different or additional types of data. For example, instead of only including an accessory SKU of an accessory category that has the most number of co-purchases, the co-purchase data used may include all accessory SKUs that have been co-purchased with the anchor SKU. In other words, the data in FIGS. 10A, 11A, and/or 11B may include co-purchase data on multiple SKUs of the same accessory product category (e.g., multiple circular saws, multiple tape measures, etc.). In various embodiments, the in-store and online co-purchase data may be combined instead of deduped. For example, instead of removing the “Circular Saw a” data from the online co-purchases as shown in FIG. 11C, the data may be combined, yielding a line in FIG. 11C showing “Circular Saw a” being co-purchased with “Plywood 1” one hundred fifty (150) times. These examples may also be implemented together. For example, if the in-store and online co-purchase data shown in FIGS. 11A and 11B includes co-purchase data for multiple SKUs in the same accessory product category, that data can be combined instead of deduped in FIG. 11C. As just one example, FIG. 11A may also include forty (40) co-purchases of “Tape Measure x,” while FIG. 11B may also include twenty-five (25) co-purchases of “Tape Measure b.” When the tables of FIGS. 11A and 11B are then combined in FIG. 11C, that can yield one hundred (100) total co-purchases of “Tape Measure x” and seventy-five (75) total co-purchases of “Tape Measure b.” Accordingly, when the data is stacked in FIG. 11C, “Tape Measure x” may still be kept as an option for accessory recommendation because it has more total co-purchases than “Tape Measure b.” Regardless of the methods used to combine in-store and online co-purchase data (e.g., as shown in FIG. 11C), the combined in-store and online co-purchase data can be used as co-purchase data as described herein. For example, the combined co-purchase data shown in FIG. 11C may be used instead of the co-purchase data shown in FIG. 10A to determine accessory recommendations according to the various methods described herein.

At the operation 314, the accessory product to recommend for the anchor product is selected from the plurality of accessory products. As described herein, the accessory product may be selected according to any combination of the operations 304, 306, 308, 310, and 312 as described herein. This selection may be made by, for example, the server 210 and/or the anchor-accessory processing system 208. This selection may serve as the determined accessory item(s) to recommend with an anchor product as discussed herein with respect to the operation 106 of FIG. 1.

In various embodiments, the anchor product for which an accessory recommendation is determined/selected does not already have an associated accessory product relationship in a list of manually entered anchor-accessory product relationships (e.g., the IRG database 204). In various embodiments, the anchor product for which an accessory recommendation is determined/selected does not already have an associated accessory product relationship that has been previously determined by the anchor-accessory processing system 208 or saved in the anchor-accessory relationship database 214. In various embodiments, an anchor product may have one or more recommended accessories in the IRG database 204 and/or the anchor-accessory relationship database 214, but the method 300 may be utilized (e.g., by the anchor-accessory processing system 208) to determine one or more additional accessory recommendations for the anchor product. Other methods described herein (e.g., the methods 400, 500, 600, 700) may also be utilized to determine one or more accessory recommendations for the anchor product, regardless of whether the anchor product has one or more accessory recommendations already stored in the IRG database 204 and/or the anchor-accessory relationship database 214.

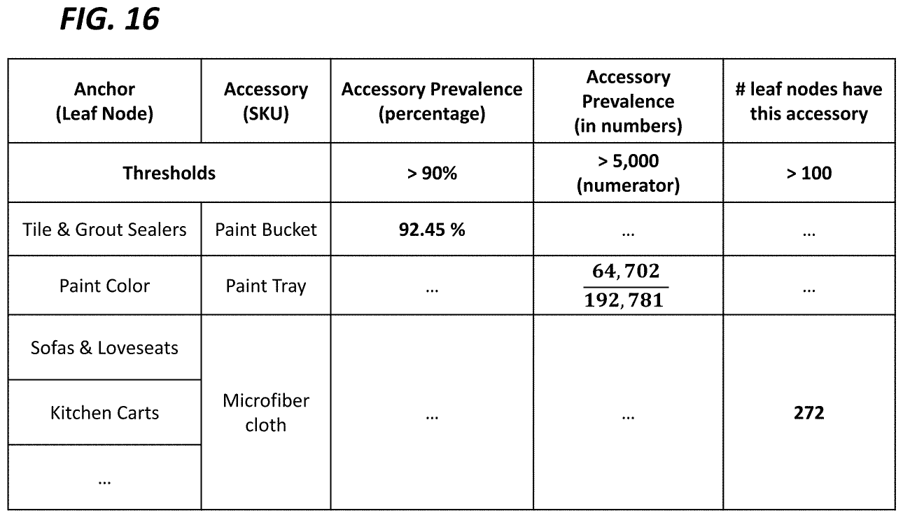

In various embodiments, a variant of the method 300 may also be utilized to determine an accessory to recommend for an anchor product or products. Examples of this variant are described with reference to FIG. 16 and may be referred to herein as determining a generic accessory that may be recommended for many anchor products and/or anchor product categories. FIG. 16 shows examples of determining generic accessory recommendations for various anchor categories of products, in embodiments.

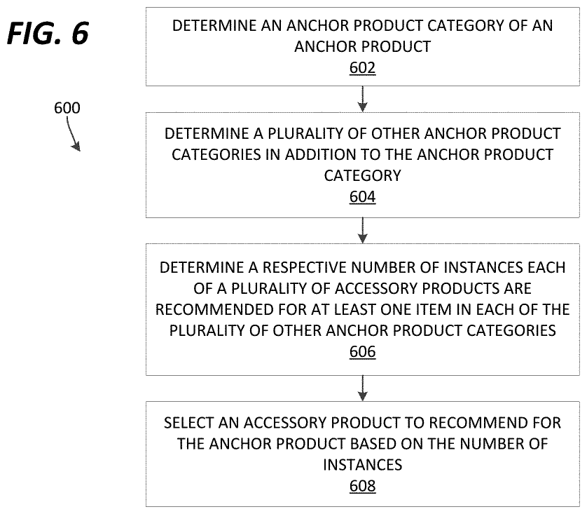

In particular, FIG. 16 shows, in the first column, four different anchor product categories: tile & grout sealers, paint color, sofas & loveseats, and kitchen carts. Any of these anchor product categories may, for example, be the anchor product category determined at the operation 302 of the method 300. In the second column, particular accessory product SKU descriptions are shown, including a paint bucket accessory product, a paint tray product, and a microfiber cloth product. These accessory product SKUs may be some of the plurality of accessory products determined from the list of manually entered anchor-accessory product relationships in the operation 306. Instead of or in addition to performing the operations 308, 310, and/or 312, the system can determine an accessory prevalence percentage (third column of FIG. 16) and/or accessory prevalence in number (fourth column of FIG. 16) of a particular accessory SKU from the plurality of accessory product. The fifth column of FIG. 16 is discussed at greater length below in combination with FIG. 6. If the accessory product reaches a certain predetermined threshold (or accessory prevalence), that accessory (or accessories) may be selected as a generic accessory product to recommend for the anchor product at the operation 314.

For example, selecting a generic accessory product to recommend for the anchor product from the plurality of accessory products (e.g., determined at the operation 306) may include determining that one of the accessory products has been recommended for (1) a predetermined percentage of products in the anchor product category in the list of manually entered anchor-accessory product relationships and/or (2) at least a predetermined number of products in the anchor product category in the list of manually entered anchor-accessory product relationships.

In the first example, as shown in the 3rd column of FIG. 16, the paint bucket product SKU has been recommended for 92.45% of the tile & grout sealer anchor products. If the predetermined percentage of products is set at 90% or greater, for example, then the paint bucket accessory product may be selected as a recommendation for any tile & grout sealer anchor products because the accessory recommendation prevalence as a percentage is higher than the predetermined percentage.

In the second example, as shown in the 4th column of FIG. 16, the paint tray has been recommended 64,702 times for 192,781 total paint color anchor products. Although as a percentage that would fall below the example predetermined percentage of products of 90%, an absolute accessory prevalence may be utilized to determine when an accessory has been recommended a high number of times. In this example, an accessory recommendation may be made if the predetermined number is higher than 5,000 recommendations from the list of manually entered. Here, the paint tray has been recommended 64,702 times for paint color anchor products so the paint tray SKU can be selected as a generic accessory product to recommend for the other paint color anchor product SKUs.

In another example embodiment, the examples of FIG. 16 may be utilized not only with the data in a manually entered database of anchor-accessory relationships (e.g., the IRG database 204), but also may be applied to a database that has other, non-manually entered anchor accessory relationships stored therein (e.g., the anchor-accessory relationship database 214). For example, generic accessories may be determined (e.g., based on accessory prevalence) after any or all of the operations 308, 310, and/or 312 are performed to add more anchor-accessory relationships to an anchor-accessory relationship database. In various embodiments, any of the other methods for determining anchor-accessory relationships may be utilized to save anchor-accessory relationships into a database (e.g., the anchor-accessory relationship database 214) before generic accessories are determined according to FIG. 16. In this way, an anchor-accessory relationship database can be robust and filled out as much as possible before examining the database for accessory prevalence or other factors for determining generic accessories according to FIG. 16. In various embodiments, determining generic accessories according to FIG. 16 may be performed after the system determines a predetermined number of accessories for as many anchor products as possible utilizing the other methods described herein. In this way, many, most, or all anchor products will have multiple anchor-accessory relationships, providing higher chances of determining generic accessories according to FIG. 16.

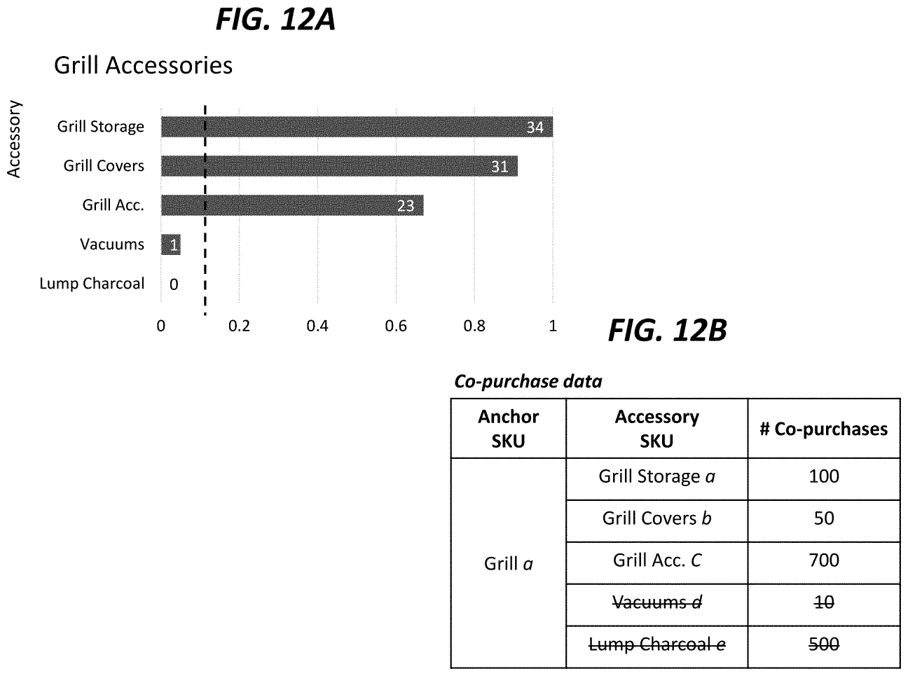

FIGS. 12A and 12B are tables showing an example of selecting accessory products based on a list of manually entered anchor-accessory product relationships and co-purchase data, in embodiments. The tables in FIGS. 12A and 12B show an example of determined accessories for a grill anchor product using the method 300 described above. For example, FIG. 12A shows manually entered anchor-accessory recommendations sorted by accessory product category, for example from the IRG database 204. In FIG. 12A, there are thirty-four (34) recommended accessories for a grill in the grill storage category, thirty-one (31) recommended accessories for a grill in the grill covers category, twenty-three (23) recommended accessories for a grill in the grill accessories category, one (1) recommended accessory for a grill in the vacuums category, and zero (0) recommended accessories for a grill in the lump charcoal category. Utilizing the confidence ratio criteria of 0.1 (the dashed line in FIG. 12A) as demonstrated in FIG. 9A, each of the grill storage, grill covers, and grill accessories product categories would qualify to select a recommended accessory therefrom (while the vacuums and lump charcoal would not). Accordingly, per the method 300, co-purchase data may be further utilized as shown in FIG. 12B for the particular “Grill a” SKU to determine one or more accessory recommendations for “Grill a.”

The “Vacuums d” and “Lump Charcoal e” SKUs are crossed off in FIG. 12B because they did not qualify based on the confidence ratio criteria applied in FIG. 12A. For the vacuum product category, this is desirable because the highest number of times a vacuum was bought with “Grill a” was ten (10) times with respect to “Vacuums d,” according to the data in FIG. 12B. This is a relatively low total. However, “Lump Charcoal e” was bought with the “Grill a” five hundred (500) times, a relatively high number compared to the other accessory SKUs in FIG. 12B. Accordingly, “Lump Charcoal e” may be a good accessory recommendation for “Grill a,” but may be missed using the method 300 because lump charcoal (as shown in FIG. 12A) was not recommended as an accessory in a manually entered list of anchor-accessory relationships. In a similar manner, some potentially good accessory recommendations may not be made if the potential accessory has not been co-purchased with the anchor product extensively. Accordingly, other methods are described below that provide other ways to determine anchor-accessory relationships. By utilizing the various methods as described herein, a robust anchor-accessory relationship database can advantageously be compiled that captures as many good anchor-accessory relationships as possible.

FIG. 4 is a flow chart illustrating an example method 400 of determining an accessory product to recommend to a user based on a text comparison, in embodiments. The method 400 may be utilized, for example, to build lists of anchor-accessory relationships between products/items, such as in the operation 102 of the method 100 in FIG. 1. The method 400 may also be performed by the anchor-accessory processing system 208 to provide accessory recommendations to the user devices 212 through the server 210 and/or to store anchor-accessory relationships in the anchor-accessory relationship database 214 as described herein.

In an operation 402, an anchor product is determined. The anchor product may be determined based on the selection of an anchor product from a user device (e.g., the operation 104 of FIG. 1). The anchor product may be determined because it has fewer than a predetermined number of anchor-accessory relationships in a manually entered list of anchor-accessory relationships (e.g., the IRG database 204) and/or an anchor-accessory relationship database (e.g., the anchor-accessory relationship database 214). The anchor product may also be determined in any other manner.

In an operation 404, a comparison is performed on product names and/or descriptions of the determined anchor product and potential accessory products. The comparison may, for example, include comparing first text associated with the anchor product to second text associated with one or more of the potential accessory products. The compared text may be mined from a product description; text of a product name; metadata associated with a product in a digital product catalog (e.g., the catalog database 206); and/or text from user comments, questions/answers, or other feedback from users (e.g., received via the user devices 212). Such text may be received, for example, through an e-commerce website where users may leave feedback, comments, questions/answers, etc. related to particular products. Such text may also be based on voice commands/feedback spoken by a user and converted into text. The comparison may be performed in part, for example, by using the text mining module 228 of FIG. 2.

The potential accessory products may be determined in various ways. For example, the potential accessory products may be any product in a catalog (e.g., the catalog database 206). In another example, the potential accessory products may be extracted from a list of entered anchor-accessory relationships (e.g., the IRG database 204, the anchor-accessory relationship database 214) using operations similar to the operations 302, 304, and 306 of the method 300 to determine a plurality of accessory products that have been recommended for anchor products of an anchor product category to which the determined anchor product belongs.

In an operation 406, based on the comparison, an accessory product of the potential accessory products is determined to recommend for the anchor product. The comparison may yield similar words in an anchor and potential accessory that suggests creating an anchor-accessory relationship between the two. The comparison may also yield a compatible attribute between an anchor and potential accessory. A selection of an accessory product may be based on that accessory product having more compatible attributes than other potential accessory products. Further examples of determining a compatible attribute between products are discussed herein (e.g., with respect to FIGS. 5, 13-15). The comparison may also be utilized to train and use an algorithm that can determine new anchor-accessory relationships. Such training and use of an algorithm is further described with respect to FIGS. 7 and 19-23.

FIG. 5 is a flow chart illustrating an example method 500 of determining attribute compatibility between an anchor and accessory product, in embodiments. The method 500 may be utilized, for example, to build lists of anchor-accessory relationships between products/items, such as in the operation 102 of the method 100 in FIG. 1. The method 500 may also be performed by the anchor-accessory processing system 208 to provide accessory recommendations to the user devices 212 through the server 210 and/or to store anchor-accessory relationships in the anchor-accessory relationship database 214 as described herein. In particular, the method 500 determines an anchor-accessory relationship where an anchor and accessory product have at least one compatible attribute.

In an operation 502, a first attribute of an anchor product and a first attribute of an accessory product are identified based on associated text. For example, the text may be product description text, text of the product names, metadata associated with the products, comments or other feedback on the products from users, or any other type of text associated with the products. The attributes may be determined based on attribute classification parameters, such as the attribute classification parameters 220 of FIG. 2. The attributes may also be determined utilizing text mining, such as the text mining of the method 400 using the text mining module 228 of FIG. 2.

As just one example, text mining and attribute classification parameters may be utilized to extract attribute values from product description of interior lighting products. For example, text in a product description may be classified as a particular attribute based on common usage of words associated with particular attributes. For example, a product description of a lighting fixture may include the text “ . . . one medium base bulb is used . . . .” A common usage of “medium base bulb” may be understood to be classified as a light bulb with corresponding base code of E26. The system may recognize the word “medium” being used next to, just before, and or near to the words “base” and/or “bulb” to determine that the base code attribute classification is being identified. The system may also classify the word “one” occurring just before “medium base bulb” to indicate that an attribute of a preferred number of bulbs for the light fixture is one. In various embodiments, text mining and attribute classification parameters may also be utilized to determine whether attributes are important for determining compatibility or not. For example, certain attributes of a product may be determined that are not helpful for determining attribute compatibility, such as the color of a broom. The attribute classification parameters can be used to help classify which determined attributes are useful for determining attribute compatibility and which ones are not. Attribute classification parameters may also be adjusted based on feedback from users.

In another example, a product description for a light fixture may include the text “ . . . two (E26) base bulbs are required . . . ” In this example, the system may identify the text “E26” next to, before, and/or near to “base” and or “bulb” and identify the E26 base code attribute. The system may also classify the word “two” occurring just before the rest of the text to indicate that an attribute of a required number of bulbs for the light fixture is two.

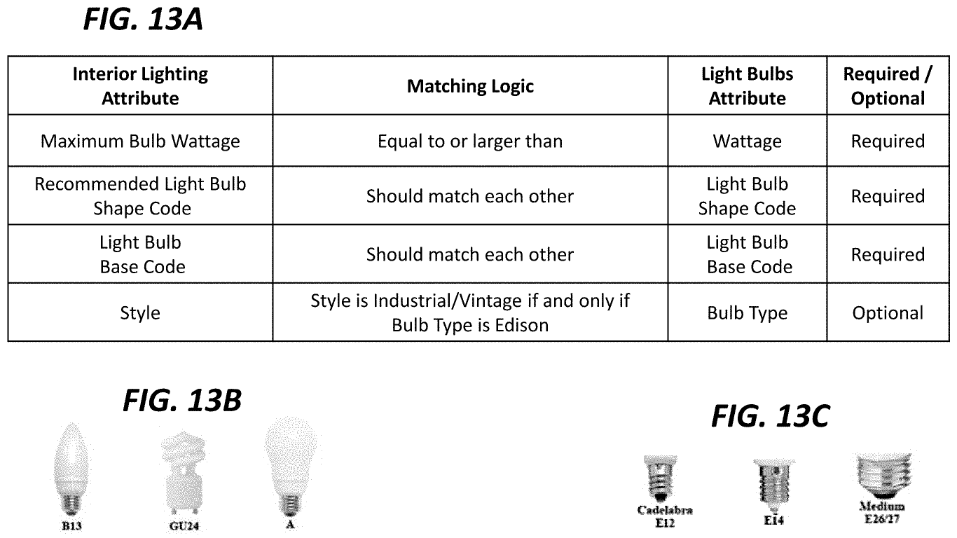

In another example, a shape code and a base code may be identified from a product description based on text mining. For example, a product description may include the text “ . . . uses three A19 E17 bulbs . . . ” The system may identify attributes of an E17 base code for a light bulb and a A19 shape code for a light bulb. This identification may occur by matching text from a product description (e.g., “A19,” “E17”) to a database of known shape and/or base codes. By locating the shape and base code text from the product description to known codes, it can identify the specific base and shape code of the product. The system may also classify the word “three” occurring just before the rest of the text to indicate that an attribute of a preferred number of bulbs for the light fixture is three. FIGS. 13B and 13C illustrates example graphical representations of different light bulb attributes, in embodiments. Examples of different bulb shape codes are shown in FIG. 13B. Examples of different bulb base codes are shown in FIG. 13C. There may be some overlap between base and shape codes in a database (e.g., some base and shape codes may be indicated by the same text). Accordingly, it may be difficult to determine a shape or base code just using text from a product description alone because the system may not know if specific text (e.g., “A19”) refers to a base or shape code. Accordingly, the system may not use product description text that does not point to a single type of attribute because it cannot determine the attribute for sure. In other embodiments, the system may use context, such as other words near the text (e.g., if shape or base appears nearer to the text) to deduce whether the text is a shape or base code and thereby resolve an issue where there is overlap between base and shape codes in a database.

Although examples of light bulb and fixture attributes shape code, base code, and number of bulbs are described above, the systems and methods described herein may determine any type of attribute of a product, such as bulb wattage, bulb style, lighting type, manufacturer name, model number, model name, power required, voltage required, part/tool size, battery size/type, color, feature, recommended use, shelf life, dimensions, weight, any other attribute, and any combination thereof.

In an operation 504, at least one compatibility rule for the anchor product and the accessory product is determined that applies to the first attribute of the anchor product and the first attribute of the accessory product. The compatibility rules may be, for example, the compatibility rules 218 discussed herein with respect to FIG. 2. A compatibility rule may also include a matching logic parameter including at least one rule that the first attribute must be lower than, lower than or equal to, equal to, equal to or larger than, or larger than the second attribute. Examples of how a compatibility rules and matching logic parameters may be utilized are discussed further below with respect to FIGS. 13A-13C, 14, and 15.

In an operation 506, a determination that the first attribute of each of the anchor product and the accessory product satisfies the compatibility rule is made (e.g., that the attributes of the anchor and accessory products are compatible). In various embodiments, one or more attributes may be identified, multiple compatibility rules may be determined, and those compatibility rules may be used to determine that the products are compatible (and therefore an anchor-accessory relationship may be established). Further examples of the method 500 are described below with respect to FIGS. 13A-13C, 14, and 15.

Various anchor products may have identifiable accessories by using the method of FIG. 5 (e.g., by determining and matching attributes). Some examples include, but are not limited to, battery accessories for power tools, extension cords for power tools, battery chargers for batteries and vice versa, saw blades for saws, drill kits for drills, abrasives for angle grinders, nails for nailers/nail guns, compressors for nailers/nail guns, hardware for millwork and vice versa, fasteners for drills/screwdrivers/drillbits and vice versa, wallplates/outlets for dimmers/switches and vice versa, smart home accessories for smart assistants, air filters for air conditioners/air coolers, water filters for water filter systems, faucet parts for faucets, door knobs for doors/cabinets, hardware for window shutters/screens/windows, window shutters/screens for windows, paint sprayer tips for paint sprayers, primers for paint colors, stair treads for trims/moldings and vice versa, surface rug pads for surface rugs, hardware for blinds, installation tools for wallpaper, faucets for vanities with tops/vanities without tops, vanity tops for vanities without tops, toilet seats for toilet bowls/tanks and vice versa, funnels for gas cans, propane for grills, safety gear for tools, and any other products for which attributes can be matched.

FIG. 13A is a table showing examples of compatibility rules for selecting recommended accessories based on attribute compatibility, in embodiments. In the first column, interior lighting fixture attributes are listed. These attributes may be identified, for example, in the operation 502 of the method 500. These interior lighting fixture attributes include a maximum bulb wattage, a recommended light bulb shape code, a light bulb base code, and a fixture style.

The compatibility rules in FIG. 13A also include a matching logic parameter in the second column. The matching logic parameters indicate how a match between an attribute of an anchor (e.g., an interior light fixture) and a determined attribute of a potential accessory (e.g., a light bulb) is determined. The third column has the light bulb attributes listed (e.g., the attribute that must match each interior lighting attribute according to the matching logic parameter). These light bulb attributes include bulb wattage, light bulb shape code, light bulb base code, and bulb type.

For the maximum bulb wattage (first row), an interior light fixture should have a wattage rating that is equal to or larger than the light bulb wattage attribute to be a match. The light bulb shape codes and light bulb base codes should match each other exactly to ensure that the light bulb actually fits with the fixture. Examples of different light bulb shape codes and light bulb base codes are shown in FIGS. 13B and 13C, respectively. For the style/bulb type attribute, the match logic parameter may be based on an if/then rule. In the example of FIG. 13A, if the style of a fixture is industrial/vintage, then a match occurs if and only if the bulb type is an Edison bulb.

In the fourth column of FIG. 13A, a required/optional parameter is indicated. For example, the first three attributes may be required to determine an accessory recommendation, while the fourth may be optional. In various examples, optional attributes may be utilized to determine a recommendation when several potential accessory products are compatible for the required attributes. In various examples where multiple accessories may be recommended for an anchor product, the optional attributes may be utilized to rank one accessory higher than another, which may also affect the accessories placement on an interface on which the anchor and accessories are displayed to a user. For example, in the interface shown in FIG. 8, a higher ranked accessory may be displayed closer to the anchor product than lower ranked accessory products (e.g.; at 806 instead of 808 or 809; at 806, 808, and/or 809 instead of a second page of accessories that are not visible in FIG. 8).

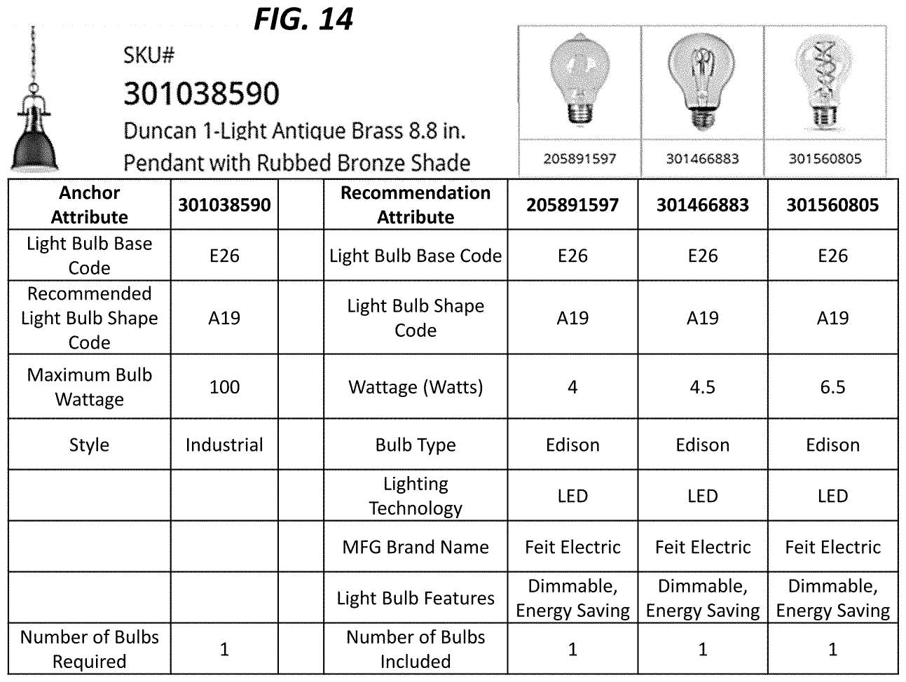

FIG. 14 is a table showing attribute compatibility of three different accessory light bulbs with an anchor light fixture, in embodiments. In particular, FIG. 14 shows three light bulbs that are all compatible with a Duncan 1-Light Antique Brass 8.8 inch Pendant with a Rubbed Bronze Shade with a SKU of 301038590. The three light bulbs have SKUs of 205891597, 301466883, and 301560805. These three bulbs may each be saved as an accessory for the anchor fixture, for example, in the anchor-accessory relationship database 214 based on their attribute compatibility with the fixture. In this way, if a user selects the fixture, the three light bulbs can be determined and presented along with the anchor item according to the method 100 of FIG. 1, for example on the user interface shown in FIG. 8 (e.g., the light fixture displayed at position 804 and the bulbs at 806, 808, and 809).

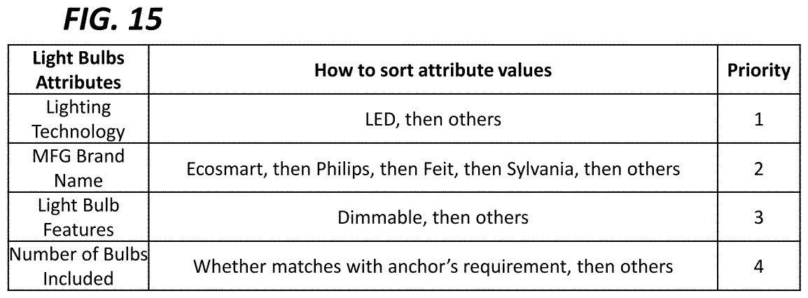

In particular, the bulbs have been determined to be compatible with the fixture because the bulbs each match the required light bulb base code, each match the light bulb shape code, and match the style/bulb type according to the compatibility rules of FIG. 13A. Further, each of the bulbs have a wattage below the maximum bulb wattage permitted for the light fixture, and therefore also meet the compatibility rules for wattage in FIG. 13A. The bulbs also match a number-of-bulbs attribute. Also listed in FIG. 14 are attributes that were determined for the accessory light bulbs, but that did not have a corresponding attribute in the light fixture (and therefore did not have a compatibility rule that must or should be met). These attributes of the bulbs include the type of lighting technology, a manufacturer brand name, and light bulb features. Similarly, an anchor product may have identified attributes for which no accessory product has an identified attribute. If the attribute for the anchor is required for an accessory in this case, no accessory may be determined using this method. If the attribute for the anchor is optional for an accessory in this case, an accessory may still be determined using this method. As described with respect to FIG. 15 below, attributes of an accessory that do not have a corresponding compatibility rule (e.g., the manufacturer, lighting technology, features) may also be used to sort or prioritize accessory recommendations and/or how they are displayed to a user.

FIG. 15 is a table showing attribute priority for determining an accessory product based on attribute compatibility, in embodiments. Optional attributes or attributes that are not associated with a compatibility rule may be utilized to determine which of several potential accessory products to recommend. In various embodiments, these optional attributes or attributes that are not associated with a compatibility rule may be utilized to rank several recommended accessories. As described herein, ranks of accessories may be utilized to determine how accessories are recommended to a user, their placement on an interface, etc.

In FIG. 15, attributes that were determined for light bulbs that were not associated with a compatibility rule (e.g., lighting technology, manufacturing brand name, light bulb features) and an optional attribute that was associated with a compatibility rule (e.g., number of bulbs) are listed in the first column. The second column indicates how to sort those attribute values. For example, for lighting technology, bulbs with LEDs are deemed superior for recommending to bulbs of other types. For manufacturer brand name, Ecosmart™ is top valued, followed by Philips™, Feit™, Sylvania™, then others, in that order. For the number of bulbs, accessories that match the optional compatibility rule are valued or ranked higher. Other attributes may also be utilized, such as profit margin, total price, whether the product is on sale, whether the product is on clearance, whether the product is an older model for which inventory is attempting to be cleared, whether the product is available in inventory, whether there are rebates available, whether the product is a white label product, whether the product is subject to a promotional marketing campaign, whether a user has previously viewed a product, or any other factor.

In the third column of FIG. 15, a priority is assigned to each attribute. In this way, the attributes can be utilized to better determine an accessory recommendation or rank accessory recommendations. For example, if one of the light bulbs in FIG. 14 was not LED, it may be ranked lower than the other light bulbs because the lighting technology attribute is configured to value LED above other types of lighting technology attributes. If a first bulb was LED but was manufactured by Sylvania™, it would still rank higher than a second bulb that was conventional lighting technology by manufactured by Ecosmart™. Even though Ecosmart™ is valued higher than Sylvania™, lighting technology has a higher priority than manufacturer brand name, so the first bulb would still be higher ranked than the second bulb (or more likely to be recommended as an accessory).

FIG. 6 is a flow chart illustrating an example method 600 of determining a generic accessory recommendation to recommend to a user, in embodiments. The method 600 may be utilized, for example, to build lists of anchor-accessory relationships between products/items, such as in the operation 102 of the method 100 in FIG. 1. The method 600 may also be performed by the anchor-accessory processing system 208 to provide accessory recommendations to the user devices 212 through the server 210 and/or to store anchor-accessory relationships in the anchor-accessory relationship database 214 as described herein. The method 600 may be utilized to determine a generic accessory that may be recommended for anchor products of several different anchor product categories. An example of how the method 600 may be utilized to determine a generic accessory is discussed below with respect to FIG. 16.

In an operation 602, an anchor product category of an anchor product is determined. The operation 602 may be performed similar to the operation 302 of FIG. 3. In an operation 604, other anchor product categories in addition to the anchor product category is determined. The other anchor product categories may be all other anchor product categories in a catalog database (e.g., the catalog database 206), may be anchor product categories in which not all of the individual anchor SKUs have an accessory product, may be anchor product categories with have a certain percentage or higher of anchors without accessory products, or may be determined some other way. Regardless of precisely how the other anchor product categories are determined, a generic accessory may be determined to be recommended for anchor products in the anchor product category and the other anchor product categories as described herein.

In an operation 606, a respective number of instances each of the accessory products are recommended for at least one item in each of the other anchor product categories is determined. In the example of the last column of FIG. 16, an accessory product, a microfiber cloth, is determined to be recommended for at least one anchor product in 272 of the anchor product categories (e.g., sofas & loveseats, kitchen carts . . . ). In this way, the system can determine if there are products that may work to be recommended for a wide variety of product types. Additionally, the generic product (e.g., the microfiber cloth) may be recommended for any of the anchor products that appear in any of the 272 anchor product categories for which it is recommended (e.g., sofas & loveseats, kitchen carts . . . ). In another example, the generic product may be recommended for any anchor product, regardless of whether the anchor product is in any of the 272 anchor product categories or not.

In an operation 608, an accessory product to recommend for a particular anchor product is selected based on the number of instances. In various embodiments, different criteria may be utilized to determine or select the accessory product to recommend. For example, an accessory product may be selected from a plurality of potential accessory products may be selected when the number of instances for the accessory product is above a predetermined number or the number of instances as a percentage of a total number of the plurality of other anchor product categories is above a predetermined percentage. In the example of FIG. 16 in the third column, the number of instances is above a predetermined number—in this case the microfiber cloth was recommended in over 100 anchor product categories. In various embodiments, if multiple accessories meet the criteria to be selected as a generic accessory, the system may select the generic accessory that has the highest number of instances or highest number of instances as a percentage of a total number of the plurality of other anchor product categories. In various embodiments, if multiple accessories meet the criteria to be selected as a generic accessory, the system may rank generic accessories according to the highest number of instances or highest number of instances as a percentage of a total number of the plurality of other anchor product categories.

FIG. 17 illustrates an example graphical presentation of a tool for verifying the output of a generic accessory recommendation generator, in embodiments. For example, a generic accessory recommendation generator may generate accessory recommendations according to the examples in FIG. 16 (and according to the methods 300 and 600 as described herein). The tool shown in FIG. 17 may be utilized for a user to verify that the recommendations are good.

At a generic accessory input 1702, the user may select a generic accessory SKU recommendation. In this example, a SKU associated with a microfiber cloth is selected, and images of the microfiber cloth are populated as the generic accessory (top row of figures) in FIG. 17. The input 1702 in this example is a drop-down menu. However, in other embodiments other types of dialogs and/or inputs may be utilized.

At a product category input 1704, the user may select which product category or division of products to view alongside the generic accessory. In this example, a kitchen carts category/division is selected. Accordingly, images of kitchen carts are populated as products in division in FIG. 17. In this way, a user can view images of a generic product and other anchor products for which the generic product is recommended to ensure that the recommendation makes sense. If the recommendation does not make sense, feedback may be provided by the user that removes the recommendation of the generic product for that category/division of anchor products. In addition, a user may also check to make sure products are being properly classified into categories/divisions by checking if the other products populated in FIG. 17 (in this example, kitchen carts) are visually homogeneous. If they are not, the user may provide feedback that may be utilized to adjust how product categories/divisions are determined.

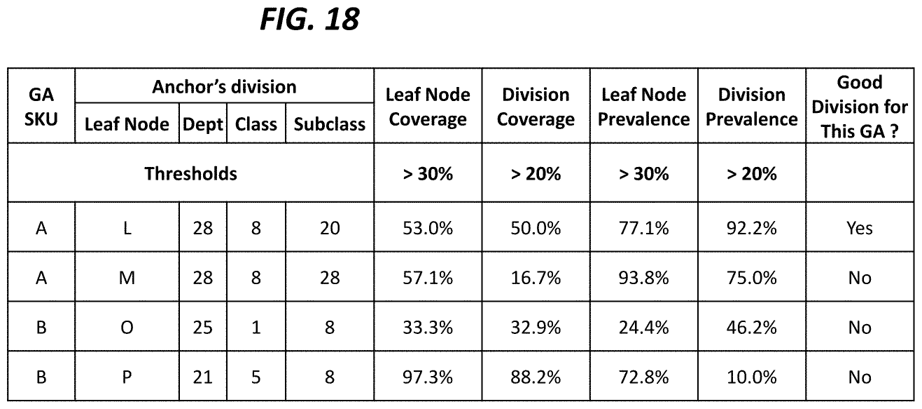

FIG. 18 is a table showing criteria for determining generic accessory recommendations, in embodiments. Although the criteria shown, for example, in FIG. 16 (and discussed with respect to the methods 300 and 600) may be utilized to determine generic accessory recommendations, additional criteria may also be applied to determine generic accessory recommendations more selectively. This may advantageously provide better accessory recommendations.

In FIG. 18, two generic SKUs “A” and “B” are considered in the first column. Utilizing criteria as described herein, the SKU “A” is considered to determine whether it should be classified as a generic accessory recommendation for two leaf nodes or anchor product categories “L” and “M.” The SKU “B” is considered to determine whether it should be classified as a generic accessory recommendation for two leaf nodes or anchor product categories “O” and “P.” In the example of FIG. 18, there are four (4) thresholds used to decide whether the product (e.g., SKU “A,” SKU “B”) is suitable to recommend as a generic product for a division of anchor product categories (e.g., “L,” “M,” “O,” “P”). Those thresholds may be set at various levels as desired. In various embodiments, different types or combinations of types of thresholds may also be used. In the example of FIG. 18, the thresholds used are leaf node coverage must be greater than 30%, division coverage must be greater than 20%, leaf node prevalence must be greater than 30%, and division prevalence must be greater than 20%. In the example of FIG. 18, all 4 thresholds must be met in the same time, but in other embodiments various selection criteria and/or combinations of selection criteria may be used. Examples of these values are shown in FIG. 18. For instance, the first row (A, L, 28, 8, 20) has values (53.0%, 50.0%, 77.1%, 92.2%) which are all higher than the desired thresholds, so the SKU “A” is suitable to recommend as a generic accessory for the products in the product category “L,” as indicated in the last column of FIG. 18. The second row (A, M, 28, 8, 28) has values (57.1%, 16.7%, 93.8, 75.0%) that do not meet the four thresholds because the “Division Coverage” column is 16.7% which is less than needed 20%. Thus, as the last column shows, the division of products of product category “M” is not a good division for the generic accessory recommendation SKU “A.” Similarly, SKU “B” is not determined to be a good recommendation for the divisions of product categories “O” and “P.”

FIG. 7 is a flow chart illustrating an example method 700 of building a list/table of anchor-accessory product relationships, in embodiments. The method 700 may be utilized, for example, to build lists of anchor-accessory relationships between products/items, such as in the operation 102 of the method 100 in FIG. 1. The method 700 may also be performed by the anchor-accessory processing system 208 to provide accessory recommendations to the user devices 212 through the server 210 and/or to store anchor-accessory relationships in the anchor-accessory relationship database 214 as described herein.

The method 700 may utilize some or all of the other methods (e.g., the methods 300, 400, 500, 600, or others) described herein for determining anchor-accessory relationships. In this way, a robust anchor-accessory relationship database may be assembled. Different methods described herein may be better for assigning anchor-accessory relationships for different types of products. Accordingly, by combining the various methods described herein, coverage (making sure as many anchor products as possible are assigned one or more accessory recommendation) can be more complete for an entire catalog of products (e.g., from the catalog database 206). In this way, a user navigating an e-commerce website, for example, can be presented with more relevant accessories along with a greater number of anchor products, reducing the number of clicks or other interactions (e.g., voice commands, touch screen gestures, etc.) a user has to make to view and potentially purchase an anchor product and relevant accessories.

In an operation 702, anchor-accessory relationships are extracted from a list of manually entered anchor-accessory product relationships to determine potential anchor-accessory relationships. This extraction may be, for example, similar to the method 300 of FIG. 3, and specifically similar to the operations 302, 304, 306, 308, and/or 310 of the method 300 as described herein.

In an operation 704, the potential anchor-accessory relationships are filtered based on co-purchase transaction data. The operation 704 may, for example, be similar to the operation 312 of the method 300 described herein. Examples of the operations 702 and 704 may additionally be described herein with respect to FIGS. 9-11. Based on the operations 702 and 704, anchor-accessory relationships are added to a list/table of anchor-accessory product relationships.

In an operation 706, anchor-accessory relationships are determined based on attribute compatibility. The operation 706 may be, for example, similar to the method 500 described herein with respect to FIG. 5. The operation 706 may also include aspects of the method 400 described herein with respect to FIG. 4. Examples of determining anchor-accessory relationships based on attribute compatibility are further described herein with respect to FIGS. 13-15. The anchor-accessory relationships determined at the operation 706 are also added to the list/table of anchor-accessory product relationships.

In an operation 708, generic anchor-accessory relationships are determined by determining products that area recommended across a large number of anchor products and/or anchor product categories. The operation 708 may include different types of generic accessory determinations as described with respect to FIGS. 16 and 18 (including with respect to the methods 300 and 600 of FIGS. 3 and 6, respectively). The anchor-accessory relationships are also added to the list/table of anchor-accessory product relationships.

In an operation 710, an algorithm is trained to learn aspects of existing anchor-accessory relationships. The existing anchor-accessory relationships may include manually entered anchor-accessory relationships (e.g., those in the IRG database 204) and/or any determined anchor-accessory relationships (e.g.; those in the anchor-accessory relationship database 214; those determined according to the operations 702, 704, 706, 708; those determined according to any of FIGS. 3-6; etc.). The algorithm may be trained, for example, utilizing transaction data (e.g., from the transaction database 202), catalog data (e.g., from the catalog database 206), utilizing the comparison as described with respect to FIG. 4, and/or any other criteria.

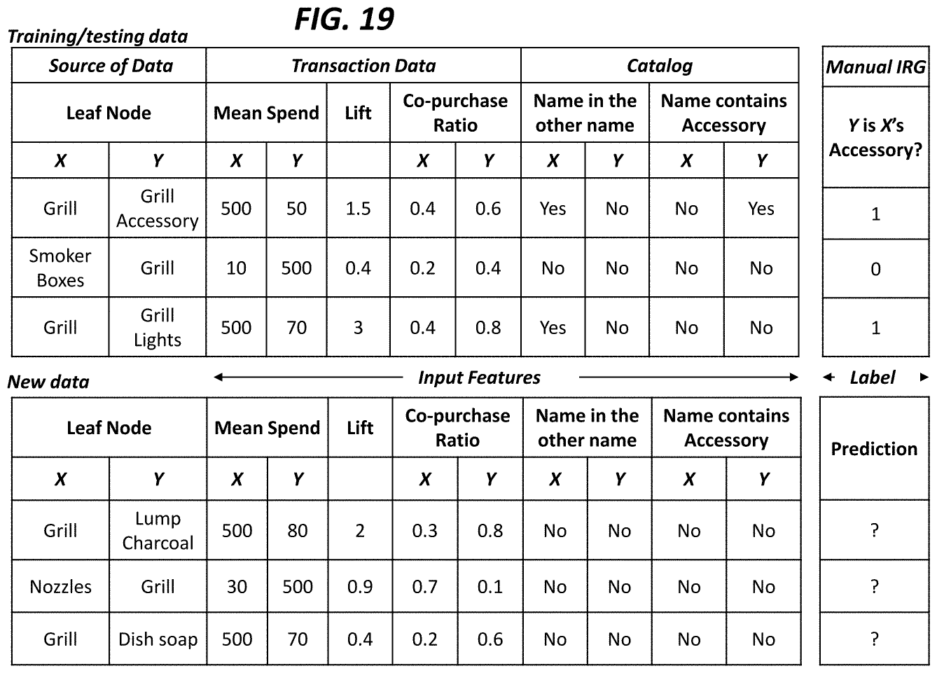

In an operation 712, the trained algorithm is utilized to predict additional anchor-accessory relationships (e.g., the trained algorithm is applied to data of potential anchor-accessory related products to determine new anchor-accessory relationships). Those additional anchor-accessory relationships are also added to the list/table of anchor-accessory product relationships. Examples of training and utilization of an algorithm for determining anchor-accessory product relationships are described herein with respect to FIGS. 19-23 below.

FIG. 19 is a table showing training/testing data for training an algorithm to determine anchor-accessory relationships and new test data to feed into a trained algorithm, in embodiments. The top half of FIG. 19 shows data relating to existing anchor-accessory relationships that is used to train an algorithm for predicting anchor-accessory relationships. In particular, an “X” column lists an anchor product category and a “Y” column lists an accessory product category. In the top half of FIG. 19, these include a grill accessory as a potential recommendation for a grill, a grill as a potential recommendation for a smoker box, and grill lights as a potential recommendation for a grill.

The input features to train the algorithm include various types of transaction data and catalog data. In various embodiments, additional or different data may be used. For example, transaction data may include mean spend for each product, a lift factor, and a co-purchase ratio. Lift factor refers to a value computed with (1) co-purchase frequency between “X” and “Y” (co-purchase (X,Y)); (2) purchase frequency of “X” (freq (X)); (3) purchase frequency of “Y” (freq (Y)); and (4) the total number of transactions (N). The lift factor may, for example, be calculated according to the following equation (1):

$$\frac{N \times Co - purchase ( X , Y )}{Freq ( X ) \times Freq ( Y )} \qquad Equation 1$$

The mean spend is how much a customer typically spends on the product when buying the product. For example, the mean spend for a grill is $500 according to FIG. 19, while the mean spend for grill lights is $70. The significantly lower mean spend for a product such as the grill lights may indicate that it is the accessory, for example. The co-purchase ratio indicates how many times the products are purchased together (a higher number can indicate that an anchor-accessory relationship is more likely). For example, for the grill and grill accessory: 40% of the time a grill is purchased a grill accessory is also purchased; 60% of the time a grill accessory is purchased a grill is also purchased.

Catalog data is also input to train the algorithm. In the example of FIG. 19, text data from the catalog is mined to determine if the products have their name in the name of the other product and if the name contains the word accessory. For example, with respect to the grill and the grill lights, the entire product name grill does appear in the name of grill lights (“yes”), but not vice versa. For grill and grill accessory, the product name grill accessory does contain the word “accessory” (“yes”), but none of the other products used as training data in FIG. 19 include the word “accessory.”

Lastly, a label of whether the product in the “Y” column is a recommended accessory for the anchor product in the “X” column is input to train the algorithm. In this example, the grill accessory is a recommended accessory for the grill and the grill lights are a recommended accessory for the grill, while the grill is not a recommended accessory for the smoker boxes. Using this training data, the algorithm can determine patterns or characteristics of the input features that indicate whether products “X” and “Y” will have an anchor-accessory relationship or not. The new data in the lower half of FIG. 19 for products that do not have a defined relationship can then be analyzed using the algorithm after it has been trained. The algorithm can then output a prediction as to whether the products in the new data “X” and “Y” columns (e.g., grill and lump charcoal) should have an anchor-accessory relationship. As described herein, anchor-accessory relationships predicted by the trained algorithm can also be added to the list/table of anchor-accessory product relationships described with respect to FIG. 7.

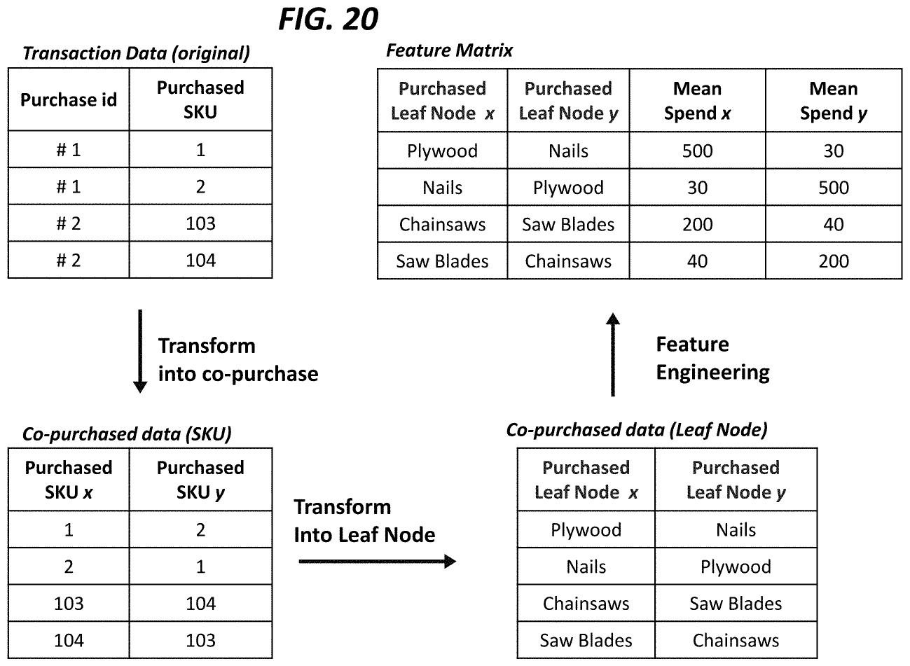

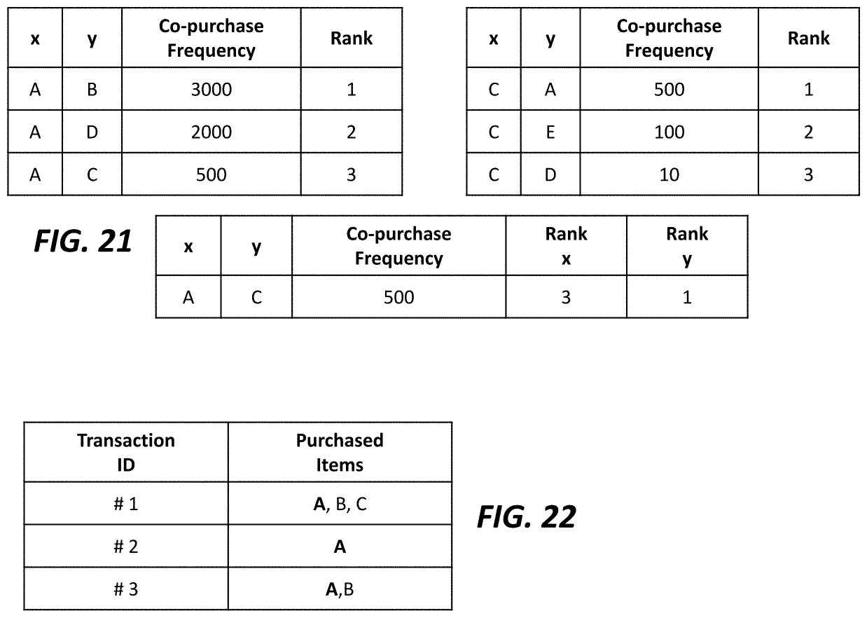

FIGS. 20-22 are tables showing data used with an algorithm for determining new anchor-accessory relationships, in embodiments. FIG. 20 demonstrates how transaction data (e.g., from the transaction database 20) may be transformed into mean spend data that may be used with an algorithm, such as the algorithm described with respect to FIG. 19. FIG. 21 shows co-purchase frequency and co-purchase frequency ranks that may be used with an algorithm, such as the algorithm described with respect to FIG. 19. FIG. 22 shows transaction data that may be used to calculate a co-purchase ratio that may be used with an algorithm, such as the algorithm described with respect to FIG. 19. In the example of FIG. 22, the co-purchase ratio of “A,” for example, is two-thirds (⅔) because “A” is purchased with other products two out of the three times “A” is purchased. The co-purchase ratio of “B” and “C,” for example, is each one (1), because each time “B” and “C” are purchased, they were purchased with another item

Accordingly, various factors may be used to both train an algorithm and feed into that algorithm to determine new anchor-accessory relationships. Different factors may take different forms and utilize different logic parameters to determine. Various example factors (with the type of data value in parentheses) may be used in various embodiments, including mean spend (float): the average of amount of money per product spent; mean quantity (float): the average of quantity per product purchased; absolute frequency (integer): the number of frequency of co-purchases between “X” and “Y” column products; relative frequency (float): absolute frequency divided by sum of all co-purchases (in-store and online); ratio of co-purchases and all purchases (float): the ratio of one product category that appears singly and overall purchases; relative co-purchase rank (integer): the rank of co-purchase frequency per product category; name contains {part, accessory} (boolean): if the product category's name contains part, accessory; name contains the other name (boolean): if one product category's name contains the other product category's name; in-store or online transaction (boolean); or any combination thereof.

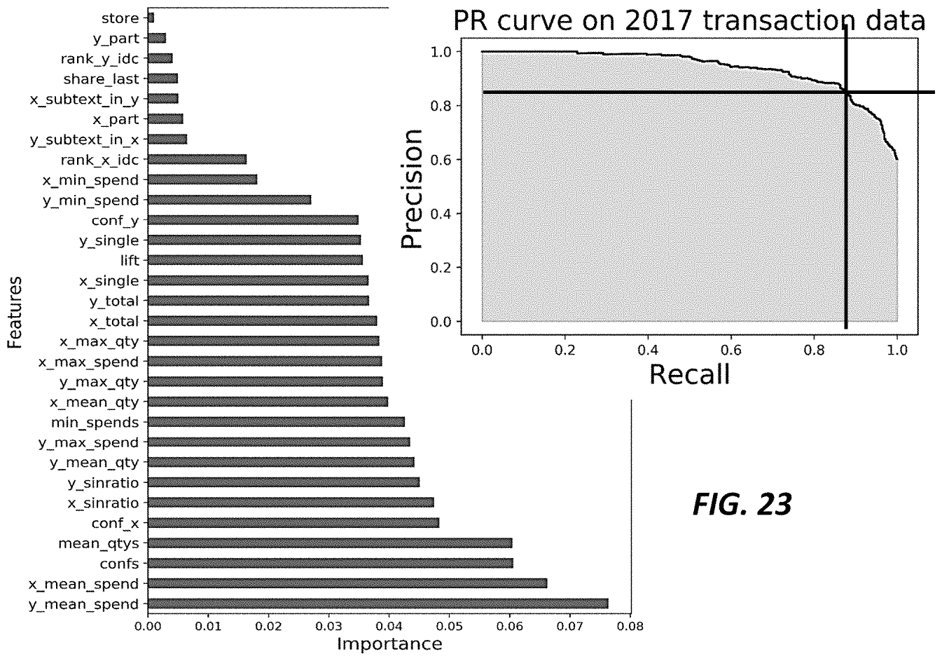

FIG. 23 illustrates example results from an example algorithm for determining new anchor-accessory relationships, in embodiments. The results show the importance of certain features in predicting an anchor-accessory relationship. In particular, it shows input features that have higher and lower importance for determining an anchor-accessory relationship. The PR curve helps demonstrate how good anchor-accessory relationship recommendations determined by the systems and methods described herein are. Ideally, a perfect PR curve would show a shaded area that covers a whole region like a square. Therefore, the closer a PR curve is to the perfect PR, the better the performance of the systems and methods herein is. Therefore, model performance can be evaluated using this PR curve. In the example of FIG. 23, the model performance is not 100% perfect, but the PR curve is close to a perfect PR curve. Thus, the model tested for FIG. 23 is reliable to some extent.

FIG. 8 illustrates an example graphical presentation 800 of an anchor product and accessory product recommendations presented to a user, in embodiments. The server 210 may provide the graphical presentation 800 as part of a website in response to a selection of the anchor item (e.g., the Ryobi™ 13 Amp 7-¼ inch Circular Saw as shown in FIG. 8). The server 210 may determine, according to the various methods described herein accessories to display along with the selected anchor product. For example, an anchor product is displayed at a position 804, and further described at a title position 802. Three accessory products are displayed along with the anchor product at positions 806, 808, and 809. An arrow 810 may be selected by the user to display even more accessory products.

In FIG. 8, accessory recommendations from different product categories are displayed, including a saw blade at the position 806, gloves at the position 808, and a battery pack at the position 809. In this way, the user may select more items than if accessories of the same product category were shown in FIG. 8. However, in various embodiments, some accessories of the same product category may be displayed. Additionally, the system is configured to receive a selection of one or more of the recommended accessory items by checking boxes 816, 818, 820 and/or a box 814 for the anchor product. These products may be added to the user's cart responsive a selection of the “ADD TO CART” button 812. These boxes and buttons are graphical control elements with which the user is able to purchase the anchor product and one or more accessory products (e.g., add the products to a user's cart). Other anchor products that may be selected are also displayed at a position 822. FIG. 8 demonstrates just one possible electronic user interface on which anchor and accessory products may be displayed according to the various embodiments described herein.

Accordingly, various embodiments for determining anchor-accessory relationships are described herein. Although the various embodiments generally described determining one or more accessories for an anchor product, it is contemplated the methods, systems, and computer readable media herein may also be used to determine accessories for product relationships that include multiple anchor products. As just one example, anchor-accessory relationships may be determined for a lamp, dimmable bulb, and dimmer switch products. For example, a dimmer switch may be an accessory for a lamp anchor product, and the dimmable bulb may be determined to be an accessory for both the lamp and the dimmer switch. In addition, if a lamp is displayed on a user interface in various embodiments, the system may ensure that any dimmer switch and dimmable bulb recommended for the lamp are compatible with one another.

In various embodiments, an anchor product for which accessories are determined may be a product already owned by a customer or potential customer. For example, previous purchases, manual inputs of products owned, public records (e.g., vehicle databases), or other sources of information may be used to determine that a customer owns a product (e.g., car, lawnmower) for which accessories may be purchased (e.g., oil filters, mower blades, wiper blades, batteries, etc.). This information of an owned anchor product may be used as described herein to determine one or more accessory relationships.

In various embodiments, an accessory recommendation factor may also be a local, state, federal, etc. regulation, rule, law, etc. For example, recommendations may vary by state based on state laws. As just one example, some chemicals are banned in California but are not banned in other states. Therefore, the system may be configured to determine a location of a user/customer and use that location to make sure it does not recommend any products that are illegal, trigger additional taxes/fees, etc. in certain jurisdictions.

In various embodiments, accessory recommendations may be customized over time based on user preferences, either preferences that are explicitly indicated or learned over time by the system. For example, a user/customer may indicate that they prefer a certain brand or type of products. The system may therefore prioritize those products, when possible, when making accessory recommendations. In another example, the previous buying behavior of a customer may be used to determine a preference for products, and that information may be used in making future recommendations to that customer. Another factor may be location, where certain groups of customers in certain locations may be known to prefer certain products or types of products.

In addition to providing accessory recommendations via a user interface like a website, accessory recommendations may be provided through other mediums as well. For example, accessory recommendations may be provided to a user/consumer/potential consumer through email, SMS text or similar, chatbot, chat apps, and non-electronic interfaces. For example a printed paper with accessory recommendations on the receipt of store order pick-up or in the box delivered to their shipping address. A printed paper directly on the physical aisle and/or bay of the store may also provide anchor-accessory relationship information. Anchor-accessory relationship information may also be provided through augmented or virtual reality interfaces. Anchor-accessory relationship information may also be provided as physical entities with the help of a human or robotic assistant (e.g., robot that can bring a customer an accessory, a 3D printer that prints an accessory). Information for determining a recommendation may be collected a human being (e.g. call center, sales associate in-store) or through a voice/virtual assistant (e.g. Google Home™, Amazon Alexa™, Apple Siri™). Similarly, accessory recommendations may be provided to a user/customer/potential customer via a human being (e.g. call center, sales associate in-store) or through a voice/virtual assistant (e.g. Google Home™, Amazon Alexa™, Apple Siri™).

FIG. 24 is a diagrammatic view of an illustrative computing system that includes a general purpose computing system environment 120, such as a desktop computer, laptop, smartphone, tablet, or any other such device having the ability to execute instructions, such as those stored within a non-transient, computer-readable medium. Furthermore, while described and illustrated in the context of a single computing system 120, those skilled in the art will also appreciate that the various tasks described hereinafter may be practiced in a distributed environment having multiple computing systems 120 linked via a local or wide-area network in which the executable instructions may be associated with and/or executed by one or more of multiple computing systems 120.

In its most basic configuration, computing system environment 120 typically includes at least one processing unit 122 and at least one memory 124, which may be linked via a bus 126. Depending on the exact configuration and type of computing system environment, memory 124 may be volatile (such as RAM 130), non-volatile (such as ROM 128, flash memory, etc.) or some combination of the two. Computing system environment 120 may have additional features and/or functionality. For example, computing system environment 120 may also include additional storage (removable and/or non-removable) including, but not limited to, magnetic or optical disks, tape drives and/or flash drives. Such additional memory devices may be made accessible to the computing system environment 120 by means of, for example, a hard disk drive interface 132, a magnetic disk drive interface 134, and/or an optical disk drive interface 136. As will be understood, these devices, which would be linked to the system bus 126, respectively, allow for reading from and writing to a hard disk 138, reading from or writing to a removable magnetic disk 140, and/or for reading from or writing to a removable optical disk 142, such as a CD/DVD ROM or other optical media. The drive interfaces and their associated computer-readable media allow for the nonvolatile storage of computer readable instructions, data structures, program modules and other data for the computing system environment 120. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 120.

A number of program modules may be stored in one or more of the memory/media devices. For example, a basic input/output system (BIOS) 144, containing the basic routines that help to transfer information between elements within the computing system environment 120, such as during start-up, may be stored in ROM 128. Similarly, RAM 130, hard drive 138, and/or peripheral memory devices may be used to store computer executable instructions comprising an operating system 146, one or more applications programs 148 (such as a Web browser, retailer's mobile app, retailer's point-of-sale checkout and ordering program, and/or other applications that execute the methods and processes of this disclosure), other program modules 150, and/or program data 152. Still further, computer-executable instructions may be downloaded to the computing environment 120 as needed, for example, via a network connection.

An end-user, e.g., a customer, retail associate, and the like, may enter commands and information into the computing system environment 120 through input devices such as a keyboard 154 and/or a pointing device 156. While not illustrated, other input devices may include a microphone, a joystick, a game pad, a scanner, etc. These and other input devices would typically be connected to the processing unit 122 by means of a peripheral interface 158 which, in turn, would be coupled to bus 126. Input devices may be directly or indirectly connected to processor 122 via interfaces such as, for example, a parallel port, game port, firewire, or a universal serial bus (USB). To view information from the computing system environment 120, a monitor 160 or other type of display device may also be connected to bus 26 via an interface, such as via video adapter 162. In addition to the monitor 160, the computing system environment 120 may also include other peripheral output devices, not shown, such as speakers and printers.

The computing system environment 120 may also utilize logical connections to one or more computing system environments. Communications between the computing system environment 120 and the remote computing system environment may be exchanged via a further processing device, such a network router 172, that is responsible for network routing. Communications with the network router 172 may be performed via a network interface component 174. Thus, within such a networked environment, e.g., the Internet, World Wide Web, LAN, or other like type of wired or wireless network, it will be appreciated that program modules depicted relative to the computing system environment 120, or portions thereof, may be stored in the memory storage device(s) of the computing system environment 120.

The computing system environment 120 may also include localization hardware 176 for determining a location of the computing system environment 120. In embodiments, the localization hardware 176 may include, for example only, a GPS antenna, an RFID chip or reader, a WiFi antenna, or other computing hardware that may be used to capture or transmit signals that may be used to determine the location of the computing system environment 120.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method of providing an accessory recommendation to a user, comprising:
receiving, from a user electronic device, a selection of an anchor product through an electronic user interface;
determining an accessory product related to the anchor product; and
sending, to the user electronic device, information about the accessory product and the anchor product to display together on the electronic user interface,
wherein the accessory product is determined to be an accessory related to the anchor product at least in part by:
determining an anchor product category of the anchor product;
determining a plurality of other anchor products that are in the anchor product category;
determining, based on the plurality of other anchor products, a plurality of accessory products from a list of manually entered anchor-accessory product relationships that are recommended for the plurality of other anchor products; and
selecting the accessory product to recommend for the anchor product from the plurality of accessory products.

2. The method of claim 1, further comprising sending, to the user electronic device for display on the electronic user interface, a graphical control element with which the user is able to purchase the anchor product and the accessory product.

3. The method of claim 2, further comprising:
receiving a selection of the graphical control element from the user electronic device; and
adding the anchor product and the accessory product to the user's cart in response to the received selection.

4. The method of claim 1, wherein the anchor product does not have an associated accessory product relationship in the list of manually entered anchor-accessory product relationships.

5. The method of claim 1, wherein a utility of the anchor product is greater when used in combination with the accessory product.

6. The method of claim 1, wherein selecting the accessory product to recommend for the anchor product from the plurality of accessory products further comprises determining that one of the plurality of accessory products been recommended for at least:
a predetermined number of products in the anchor product category in the list of manually entered anchor-accessory product relationships or
a predetermined percentage of products in the anchor product category in the list of manually entered anchor-accessory product relationships.

7. The method of claim 1, wherein selecting the accessory product to recommend for the anchor product from the plurality of accessory products further comprises:
determining a plurality of accessory product categories, wherein each of the plurality of accessory products is in at least one of the plurality of accessory product categories; and
determining a number of instances, for each of the plurality of accessory product categories, in which any of the plurality of accessory products is recommended for the anchor product category in the list of manually entered anchor-accessory product relationships.

8. The method of claim 7, wherein selecting the accessory product to recommend for the anchor product further comprises selecting from one of the plurality of accessory products that is in one of the plurality of accessory product categories that has:
the number of instances above a predetermined number or
the number of instances as a percentage of a total number of products in the anchor product category above a predetermined percentage.

9. The method of claim 1, wherein selecting the accessory product to recommend for the anchor product from the plurality of accessory products further comprises determining which of the plurality of accessory products has been co-purchased with the anchor product a highest number of times.

10. The method of claim 9, further comprising determining which of the plurality of accessory products has been co-purchased with the anchor product from co-purchase data comprising records of purchases through a website or mobile application and records of purchases in one or more brick-and-mortar stores.

11. The method of claim 1, wherein selecting the accessory product to recommend for the anchor product from the plurality of accessory products further comprises determining that the accessory product and the anchor product have at least one compatible attribute.

12. The method of claim 11, wherein determining that the accessory product and the anchor product have at least one compatible attribute comprises performing text mining on product names or descriptions of the accessory product and the anchor product to determine the at least one compatible attribute.

13. The method of claim 1, wherein selecting the accessory product to recommend for the anchor product from the plurality of accessory products further comprises determining that the accessory product and the anchor product have more compatible attributes than other accessory products of the plurality of accessory products.

14. The method of claim 1, wherein selecting the accessory product to recommend for the anchor product from the plurality of accessory products further comprises:
determining a plurality of other anchor product categories in addition to the anchor product category; and
determining a number of instances each of the plurality of accessory products are recommended for at least one item in each of the plurality of other anchor product categories.

15. The method of claim 14, further comprising selecting the accessory product to recommend for the anchor product from the plurality of accessory products comprises selecting the accessory product from one of the plurality of accessory products that has:
the number of instances above a predetermined number or
the number of instances as a percentage of a total number of the plurality of other anchor product categories is above a predetermined percentage.

16. The method of claim 1, further comprising:
establishing an anchor-accessory relationship between the accessory product and the anchor product in response to the selecting of the accessory product to recommend for the anchor product; and
storing the anchor-accessory relationship in a lookup table, wherein receiving the selection of the anchor product through the electronic user interface occurs after the anchor-accessory relationship is stored in the lookup table such that the determination of the accessory product is accomplished by locating the anchor-accessory relationship in the lookup table.

17. A method of providing an accessory recommendation to a user, comprising:
receiving, from a user electronic device, a selection of an anchor product through an electronic user interface;
determining an accessory product related to the anchor product; and
sending, to the user electronic device, information about the accessory product and the anchor product to display together on the electronic user interface,
wherein the accessory product is determined to be an accessory related to the anchor product at least in part by:
determining a plurality of potential accessory products;
comparing first text associated with the anchor product to respective second text associated with each of the plurality of potential accessory products;
selecting, based on the comparison of the first text to the second texts, the accessory product to recommend for the anchor product from the plurality of accessory products.

18. The method of claim 17, further comprising sending, to the user electronic device for display on the electronic user interface, a graphical control element with which the user is able to purchase the anchor product and the accessory product.

19. The method of claim 18, further comprising:
receiving a selection of the graphical control element from the user electronic device; and
adding the anchor product and the accessory product associated with the graphical control element to the user's cart in response to the received selection.

20. The method of claim 17, wherein a utility of the anchor product is greater when used in combination with the accessory product.

21. The method of claim 17, wherein the first text associated with the anchor product comprises at least one of a name of the anchor product and a description of the anchor product.

22. The method of claim 17, wherein the respective second text associated with each of the potential accessory products comprises at least one of respective names of the plurality of potential accessory products or respective descriptions of the plurality of potential accessory products.

23. The method of claim 17, wherein selecting the accessory product to recommend based on the comparison further comprises determining that the accessory product and the anchor product have at least one compatible attribute.

24. The method of claim 23, wherein determining that the accessory product and the anchor product have at least one compatible attribute comprises:
identifying a first attribute of the anchor product and a first attribute of the accessory product based on product description text of the anchor product and the accessory product;
determining a compatibility rule for the anchor product and the accessory product; and
determining that the first attribute of the anchor product and the first attribute of the accessory product satisfy the compatibility rule.

25. The method of claim 24, wherein the compatibility rule comprises a matching logic parameter comprising at least one rule that the first attribute must be:
lower than,
lower than or equal to,
equal to,
equal to or larger than, or
larger than the second attribute.

26. The method of claim 17, wherein the first text associated with the anchor product is a product name of the anchor product and the respective second text associated with the plurality of potential accessory products is product names of the plurality of potential accessory products, and further wherein selecting the accessory product to recommend for the anchor product comprises determining that at least one word in the product name of the anchor product matches a product name of one of the plurality of potential accessory products.

27. A method of determining a list of anchor-accessory relationships, comprising:
determining a first anchor-accessory relationship based on a list of manually entered anchor-accessory product relationships, wherein determining the first anchor-accessory relationship comprises:
determining an anchor product category of a first anchor product that is not associated with any anchor-accessory relationship in the list of manually entered anchor-accessory product relationships;
determining a plurality of other anchor products that are in the anchor product category;
determining, based on the plurality of other anchor products in the anchor product category, a plurality of accessory products from the list of manually entered anchor-accessory product relationships that are recommended for the plurality of other anchor products;
determining that a first accessory product of the plurality of accessory products has been co-purchased with the anchor product a highest number of times among the plurality of accessory products;
establishing the first anchor-accessory relationship between the first anchor product and the first accessory product; and
storing the first anchor-accessory relationship between the first anchor product and the first accessory product in the list of anchor-accessory product relationships;
determining a second anchor-accessory relationship based on attribute compatibility, wherein determining the second anchor-accessory relationship comprises:
determining that a second accessory product and a second anchor product have at least one compatible attribute based on product names or descriptions of the second accessory product and the second anchor product;
establishing the second anchor-accessory relationship between the second anchor product and the second accessory product; and
storing the second anchor-accessory relationship between the second anchor product and the second accessory product in the list of anchor-accessory product relationships;
receiving, from a user electronic device, a selection of the first anchor product or the second anchor product through an electronic user interface;
determining, based on the list of anchor-accessory relationships, a correct accessory product related to the selection; and
sending, to the user electronic device, information about the correct accessory product related to the selection to display on the electronic user interface.

28. The method of claim 27, wherein the selection is a first selection, and wherein the method further comprises:
sending, to the user electronic device for display on the electronic user interface, a graphical control element with which the user is able to purchase the correct accessory product related to the selection;
receiving a second selection of the graphical control element from the user electronic device; and
adding the correct accessory product associated with the selected graphical control element to the user's cart in response to the second selection.
